(19) United States
(12) Patent Application Publication
(10) Pub. No.: US 2026/0370624 A1
(43) Pub. Date: Nov. 19, 2026

(54) CROSS-LEDGER ASSET TRANSACTION MANAGEMENT

(71) Applicant: D3SERVE LABS INC, Sunnyvale, CA (US)

(72) Inventors: Zainan Zhou, Sunnyvale, CA (US); Sami Sameer Ibrahim Almishal, Sunnyvale, CA (US)

(21) Appl. No.: 19/680,121

(22) Filed: May 18, 2026

Related U.S. Application Data
(60) Provisional application No. 63/807,989, filed on May 19, 2025.

(51) Int. Cl. H04L 61/3015

(52) U.S. Cl. CPC H04L 61/3025

(57) ABSTRACT

Ways for managing a domain name transaction for a user across a centralized ledger and a distributed ledger are provided that include a system having a processor and a memory in communication with the processor. The memory includes an orchestration layer that includes an application programming interface (API) and a communication module. The API receives the domain name transaction from the user. The orchestration layer receives, via the API, the domain name transaction from the user. The orchestration layer sends, via the communication module, the domain name transaction to the centralized ledger, The orchestration layer receives, via the communication module, registration information from the centralized ledger. The orchestration layer mints, via the communication module, a non-fungible token (NFT) on the distributed ledger, the NFT including the registration information. The orchestration layer then synchronizes the registration information with metadata of the NFT across the centralized ledger and the distributed ledger.

### CROSS-REFERENCE TO RELATED APPLICATIONS

This application claims the benefit of U.S. Provisional Application No. 63/807,989, filed on May 19, 2025. The entire disclosure of the above application is incorporated herein by reference.

### FIELD

The present technology relates to digital asset management systems and methods, and, more particularly, to systems and methods for managing domain name transactions across distributed and centralized ledger systems.

### INTRODUCTION

This section provides background information related to the present disclosure which is not necessarily prior art.

Domain name management can be a complex undertaking that spans multiple administrative and technical systems. Internet domain names represent a unique class of digital assets that serve as foundational identifiers for online resources, linking human-readable names to underlying network infrastructure. Centralized domain registrars for managing digital assets such as those used for internet domain names can be siloed, creating inefficiencies and interoperability challenges. These domain registrars can rely on the Domain Name System (DNS) and the Extensible Provisioning Protocol (EPP) to manage domain registrations, transfers, and renewals. The siloed nature of these centralized architectures can place meaningful constraints on the ability of registrars, operators, and users to manage domain name assets in a unified and efficient manner.

Certain centralized authorities, such as the Internet Corporation for Assigned Names and Numbers (ICANN) and domain registrars, can serve as the primary custodians of domain name records. These systems rely on the Domain Name System (DNS) and Extensible Provisioning Protocol (EPP) to manage domain registrations, transfers, and renewals. However, these protocols can lack native support for integrating with certain domain name management systems, such as distributed ledger technologies (DLTs). This absence of native interoperability support can necessitate custom bridging solutions that, in turn, introduce additional architectural complexity and operational risk.

The emergence of distributed ledger technologies introduces new paradigms for asset ownership and transfer that operate under fundamentally different architectural principles than centralized domain registration systems. Blockchain-based systems can include technologies such as non-fungible tokens (NFTs) to represent and manage unique digital assets. Blockchain systems can operate under different architectural principles compared to centralized systems, utilizing decentralized networks and cryptographic validation mechanisms. The divergence between these two paradigms can make it difficult to achieve unified governance over digital assets that span both types of systems.

The lack of standardization and interoperability between blockchain systems and centralized systems can hinder cross-system asset management. Organizations attempting to utilize both systems can face redundant processes and increased complexity. In certain cases, the absence of a unified architectural framework can require operators to maintain parallel administrative workflows for the same domain name asset across both centralized and distributed environments. These redundant workflows can increase operational overhead and the likelihood of discrepancies between asset records maintained on different systems.

Centralized and distributed domain ledgers can also include discrepancies between the verification processes in centralized systems versus blockchain systems. Centralized systems can involve manual reconciliation processes or centralized bridging solutions that introduce additional points of failure. These manual processes can lead to errors in asset tracking and discrepancies in asset status between ledgers. In addition, centralized bridging solutions can undermine the decentralized benefits of blockchain systems by introducing intermediary dependencies, which conflict with the autonomous nature of blockchain operations.

The cryptographic verification and consensus mechanisms inherent in blockchain operations can be incompatible with the procedural and protocol-based methods used in centralized systems. Certain solutions can employ inconsistent methodologies to guarantee synchronization, leading to potential inconsistencies between the representation of an asset on different systems. Complications in management between centralized and distributed domain ledgers can also arise in the context of lifecycle management across these systems. Centralized systems can be designed for straightforward, linear processes concerning assets, whereas blockchain systems can support more dynamic and programmatically enforceable asset lifecycle states. This disparity can result in complex situations when attempting to manage domain name issuance, transfers, or renewals, as these processes can be required to be consistently mirrored across both systems without loss of data integrity or loss of synchronization.

Regulatory and security considerations can pose technical and logistical hurdles when integrating centralized and distributed domain name management systems. Centralized systems can have standardized oversight and compliance requirements that can be difficult to align with distributed systems, including anonymous operations within blockchain networks. A significant technical challenge can exist in maintaining consistency between these disparate ledger systems, particularly when establishing dependable relationships between transactions occurring on different ledgers. Certain domain import procedures can raise additional complications, as authorization code verification and domain status verification can frequently fail due to conditions that require the user to take corrective action at their external registrar. Specifically, a domain can still be locked for transfer, requiring EPP unlock, or the authorization code provided can be incorrect or expired. These failure conditions require ongoing coordination between the user and the underlying workflow system, adding further complexity to cross-ledger asset management.

There is a continuing need for a system and methods for managing domain name transactions across centralized and distributed ledger systems. Desirably, such systems and methods can address the inefficiencies arising from siloed centralized architectures and the interoperability challenges between centralized domain registrars and blockchain-based distributed ledger systems, and can resolve the inconsistencies and data integrity risks introduced by manual reconciliation processes and centralized bridging solutions.

### SUMMARY

In concordance with the instant disclosure, systems and methods for managing domain name transactions across centralized and distributed ledger systems have surprisingly been discovered.

The present technology includes ways of managing domain name transactions across centralized and distributed ledger systems through a persistent, repetitious workflow architecture that can coordinate domain name lifecycle events including issuance, importation, transfer, expiration updates, and renewal across centralized domain name registrars and blockchain-based distributed ledger systems, while maintaining synchronization, state persistence, and data integrity between the two. The present technology improves upon certain domain name management systems by addressing the interoperability gaps and operational limitations that can be found when managing domain name assets across centralized registrar systems and blockchain-based distributed ledger systems. Centralized domain name management can be characterized by siloed architectures that rely on the Domain Name System (DNS) and the Extensible Provisioning Protocol (EPP), while distributed ledger systems can be characterized by decentralized cryptographic validation mechanisms and non-fungible tokens (NFT)-based asset representations, two paradigms that can be inherently incompatible without a coordinating architecture between them. The present technology improves upon certain manual reconciliation and centralized bridging approaches, which can introduce additional points of failure, data inconsistencies, and redundant administrative processes, by providing a persistent, repetitious workflow architecture that coordinates domain name lifecycle events across both ledger types in a synchronized and state-persistent manner.

The present technology can also find applicability in various contexts, including cross-ledger digital asset management scenarios, such as the management of unique digital assets including collectibles, intellectual property rights, real property records, securities and financial instruments, software licenses, and other tokenized assets that can be represented as cryptographically unique assets on a distributed ledger while a corresponding record of ownership, rights, or registration can be maintained on a centralized ledger, and other multi-ledger asset synchronization scenarios. The present technology contemplates the use of various applications and can be implemented and described herein through a system that provides domain name lifecycle events synchronized across a centralized ledger and a distributed ledger. It should be understood that the present technology is not limited to domain name management applications and can also be used in the above-mentioned and other circumstances involving lifecycle management and synchronization of digital assets across disparate centralized and distributed ledger architectures. The present description of domain name management implementations provides an illustrative example of the present technology that is non-limiting and used solely as a model in describing the present technology.

In certain embodiments, a system for managing a domain name transaction for a user across a centralized ledger and a distributed ledger is provided. The system can include a processor and a memory in communication with the processor. The memory can include an orchestration layer that further includes an application programming interface (API) and a communication module. The API can receive the domain name transaction from the user. The orchestration layer can receive, via the API, the domain name transaction. The system can send, via the communication module, the domain name transaction to the centralized ledger. The system can receive, via the communication module, registration information from the centralized ledger. The system can mint, via the communication module, a non-fungible token (NFT) on the distributed ledger, the NFT including the registration information. The system can synchronize the registration information with metadata of the NFT across the centralized ledger and the distributed ledger.

In certain embodiments, a method for managing the domain name transaction for the user across the centralized ledger and the distributed ledger is provided. The method can include a step of providing the system for managing the domain name transaction for the user across the centralized ledger and the distributed ledger described herein above. The method can include a step of receiving, via the API, the domain name transaction from the user. The method can include a step of sending, via the communication module, the domain name transaction to the centralized ledger. The method can include a step of receiving, via the communication module, registration information from the centralized ledger. The method can include a step of minting, via the communication module, the NFT on the distributed ledger, the NFT including the registration information. The method can include a step of synchronizing the registration information with metadata of the NFT across the centralized ledger and the distributed ledger.

In certain embodiments, a non-transitory computer-readable medium is provided, operable to store processor instructions for managing the domain name transaction for the user across the centralized ledger and the distributed ledger. When the processor instructions are executed by the processor, the processor instructions can cause the processor to receive, via the API of the orchestration layer, the domain name transaction from the user. The processor instructions can cause the processor to send, via the communication module of the orchestration layer, the domain name transaction to the centralized ledger. The processor instructions can cause the processor to receive, via the communication module, registration information from the centralized ledger. The processor instructions can cause the processor to mint, via the communication module, the NFT on the distributed ledger, the NFT including the registration information. The processor instructions can cause the processor to synchronize the registration information with metadata of the NFT across the centralized ledger and the distributed ledger.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIGS. 1 and 2 are block diagrams illustrating aspects of a system for managing a domain name transaction for a user across a centralized ledger and a distributed ledger;

FIG. 3 is a block diagram illustrating further aspects of the system for managing the domain name transaction for the user across the centralized ledger and the distributed ledger;

FIGS. 4A-4D provide a sequence diagram illustrating aspects of initiation and execution of the system for managing the domain name transaction;

FIGS. 5A-5E provide a sequence diagram illustrating aspects of a complete interactive import workflow for managing the domain name transaction;

FIG. 6 is a sequence diagram illustrating aspects of an import workflow without errors;

FIGS. 7A-7C provide a sequence diagram illustrating aspects of an error recovery where a domain unlock is required;

FIGS. 8A and 8B provide a sequence diagram illustrating aspects of an error recovery where an authorization code update is required;

FIG. 9 is a sequence diagram illustrating aspects of signal communication pattern;

FIG. 10 illustrates a payment workflow according to an embodiment of a payment protocol hierarchy;

FIGS. 11A-11C illustrate a decision logic diagram of an interactive import workflow according to an embodiment of the system;

FIGS. 12A and 12B provide a flowchart illustrating an embodiment of a method for managing the domain name transaction for the user across the centralized ledger and the distributed ledger;

FIG. 13 provides a flowchart extending from FIGS. 12A and 12B and further illustrates a method for managing the domain name transaction across the centralized ledger and the distributed ledger;

FIG. 14 provides a flowchart extending from FIGS. 12A and 12B and further illustrates a method for managing the domain name transaction across the centralized ledger and the distributed ledger; and

FIG. 15 provides a flowchart extending from FIGS. 12A and 12B and further illustrates a method for managing the domain name transaction across the centralized ledger and the distributed ledger.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as can be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items can be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that can arise from ordinary methods of measuring or using such parameters.

Although the open-ended term “comprising,” as a synonym of non-restrictive terms such as including, containing, or having, is used herein to describe and claim embodiments of the present technology, embodiments can alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that can be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter can define endpoints for a range of values that can be claimed for the parameter. For example, if Parameter X is exemplified herein to have value A and also exemplified to have value Z, it is envisioned that Parameter X can have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1–10, or 2–9, or 3–8, it is also envisioned that Parameter X can have other ranges of values including 1–9, 1–8, 1–3, 1–2, 2–10, 2–8, 2–3, 3–10, 3–9, and so on.

When an element or layer is referred to as being “on,” “engaged to,” “connected to,” or “coupled to” another element or layer, it can be directly on, engaged, connected or coupled to the other element or layer, or intervening elements or layers can be present. In contrast, when an element is referred to as being “directly on,” “directly engaged to,” “directly connected to” or “directly coupled to” another element or layer, there can be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed contents.

Although the terms first, second, third, etc. can be used herein to describe various elements, components, regions, layers and/or sections, these elements, components, regions, layers and/or sections should not be limited by these terms. These terms can be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, can be used herein for ease of description to describe one element or feature's relationship to another element(s) or feature(s) as illustrated in the figures. Spatially relative terms can be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device can be otherwise oriented (rotated 90 degrees or at other orientations) and the spatially relative descriptors used herein interpreted accordingly.

The present technology provides a way to manage digital assets across two different types of record-keeping systems at the same time. These systems can be kept in sync automatically, without the need for manual intervention. Errors that can arise during the process can be caught and communicated to a user, who can then take corrective action before the process resumes. Payments for asset transactions can be made in both traditional currency and cryptocurrency, creating a reliable, more flexible, and less error-prone way to manage digital assets across systems that would otherwise be difficult to coordinate.

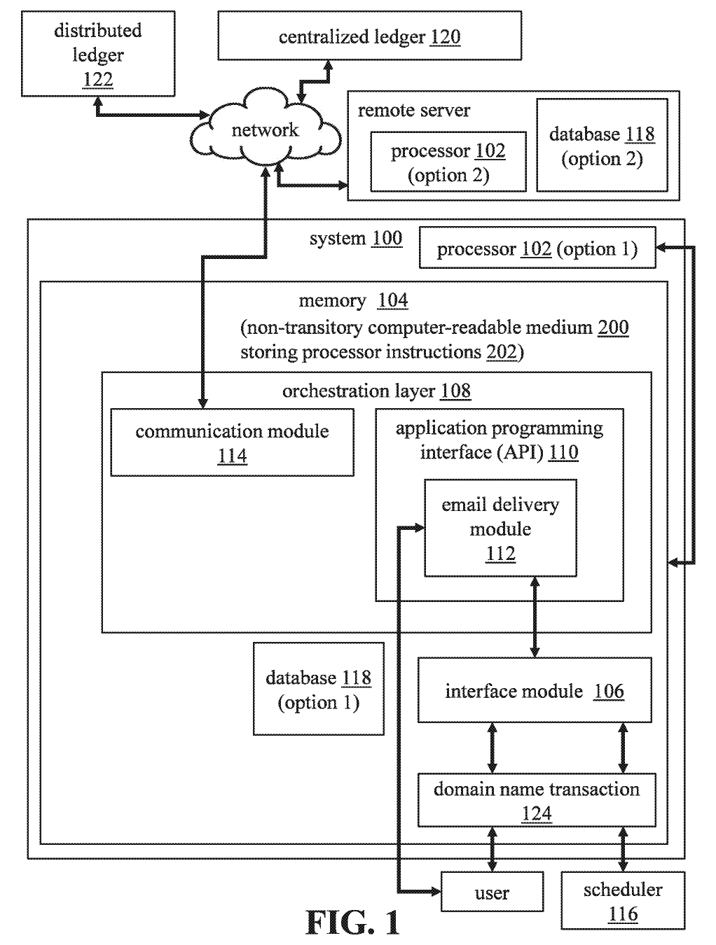

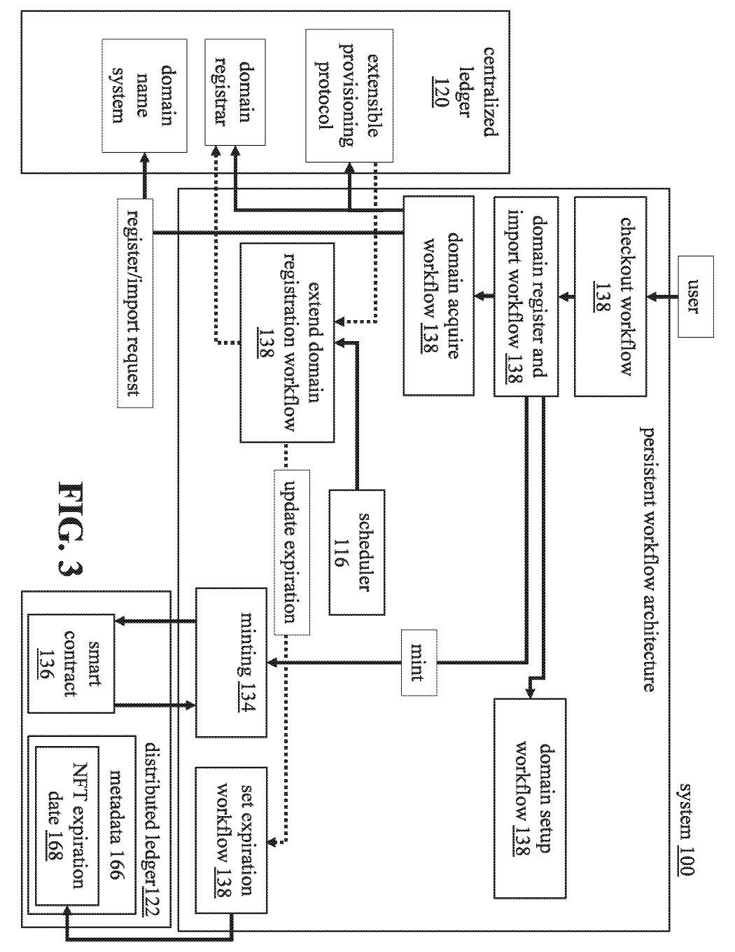

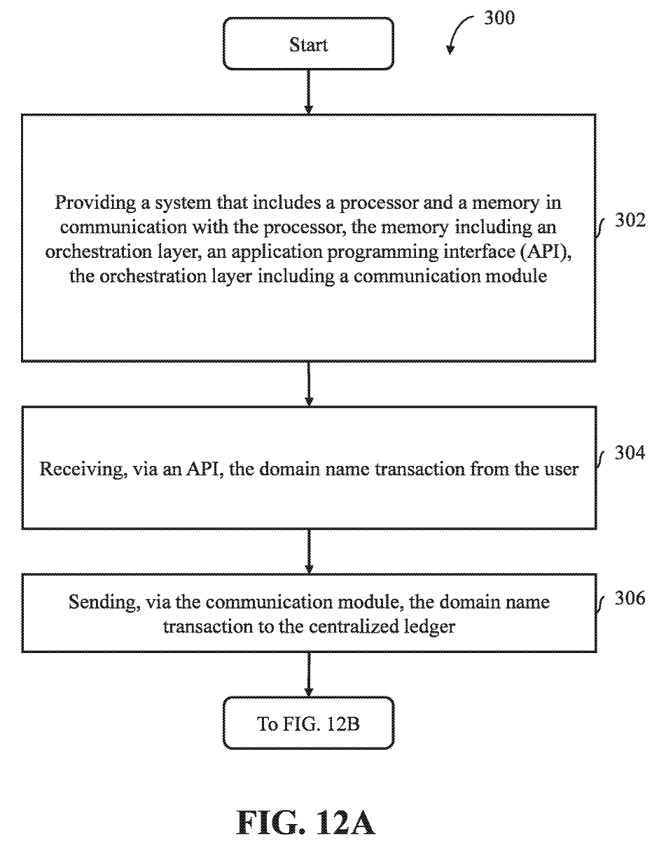

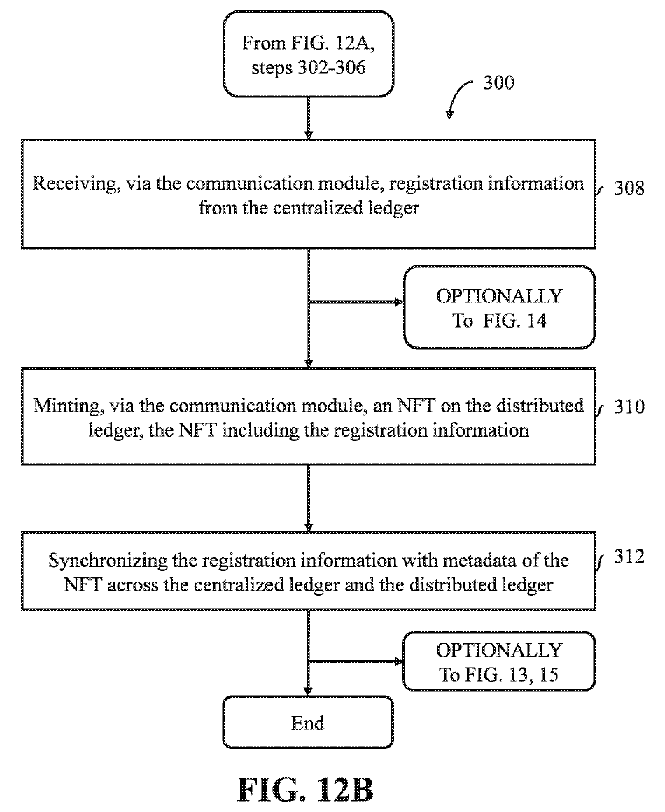

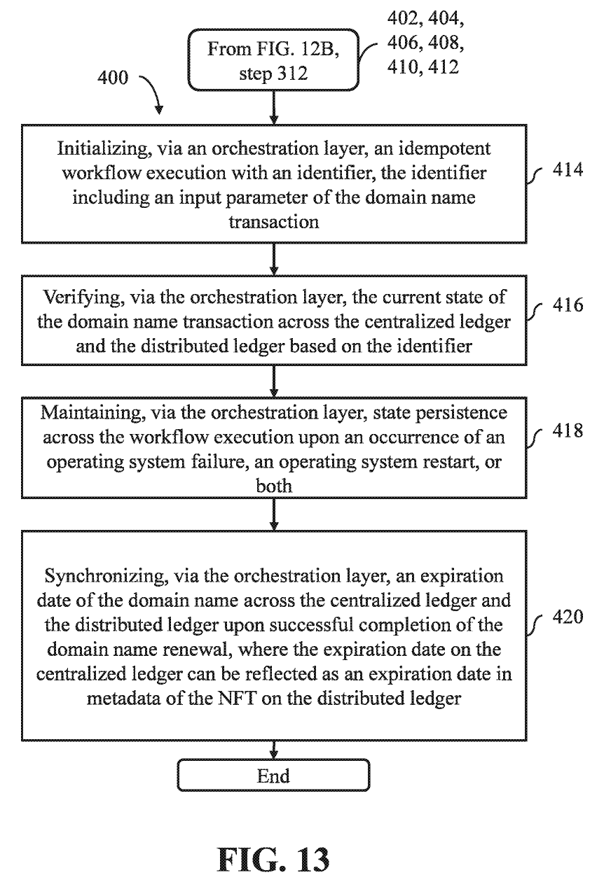

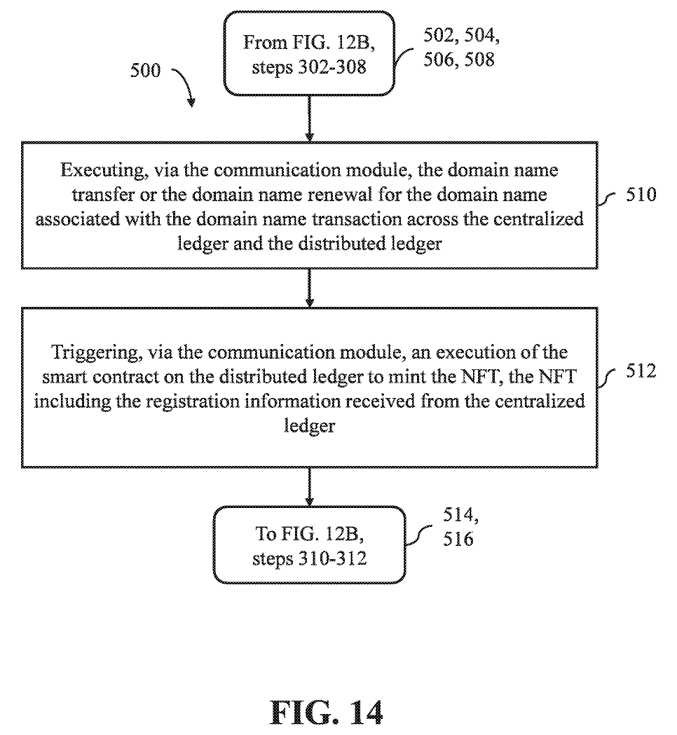

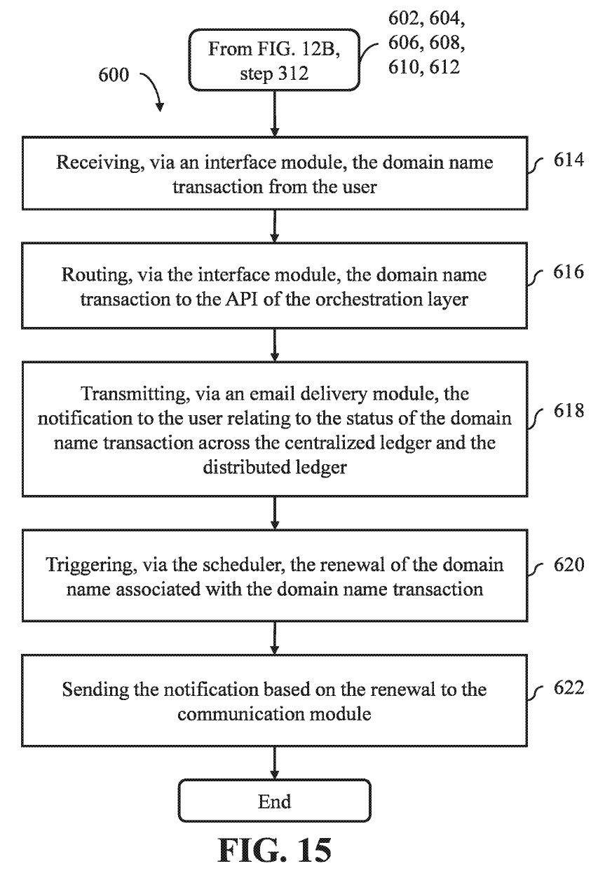

Ways for managing digital assets across a centralized ledger and a distributed ledger are provided, aspects of which are shown generally in accompanying FIGS. 1-15. The present technology provides a system 100 and non-transitory computer-readable medium 200 for managing a domain name transaction for a user across a centralized ledger and a distributed ledger, aspects of which are shown generally in accompanying FIGS. 1-11C. A method 300 for managing a domain name transaction across a centralized ledger and a distributed ledger is also provided, aspects of which are shown in FIGS. 12A and 12B. A method 400 for managing a domain name transaction across a centralized ledger and a distributed ledger is also provided, aspects of which are shown in FIG. 13. Another method 500 for managing a domain name transaction across a centralized ledger and a distributed ledger is also provided, aspects of which are shown in FIG. 14. Yet another method 600 for managing a domain name transaction across a centralized ledger and a distributed ledger is also provided, aspects of which are shown in FIG. 15.

The system 100, and non-transitory computer-readable medium 200, and methods 300, 400, 500, and 600 allow for managing a domain name transaction across both a centralized ledger and a distributed ledger. As shown in FIGS. 1-11C, the system 100 can include a processor 102 and a memory 104 in communication with the processor 102. The memory 104 can include an interface module 106 and an orchestration layer 108. The orchestration layer 108 can include an application programming interface (API) 110. The API 110 can include an email delivery module 112. The orchestration layer 108 can also include a communication module 114. The memory 104 can also include a scheduler 116, and a database 118. The system 100 can be in communication, via the communication module 114, with a centralized ledger 120 and a distributed ledger 122.

Referring generally to FIGS. 1-3, the system 100 for managing a domain name transaction 124 for a user across a centralized ledger 120 and a distributed ledger 122 can rely on a persistent, repetitious workflow architecture that coordinates domain name lifecycle events across centralized and blockchain-based registrar systems. The system 100 can be further adapted to support long-running workflow operations spanning multiple years, corresponding to the full duration of domain name registration periods, thereby providing a framework suited to the entire domain name lifecycle. The system 100 can also address interoperability challenges between blockchain-based distributed systems and centralized domain name registrar systems by reducing manual reconciliation efforts through the use of persistent, repetitious workflow architecture.

The processor 102 can control the system 100 to execute various modules and components for domain name management and cross-ledger data synchronization operations. The processor 102 can include a local processor, shown as the processor 102 option 1 in FIG. 1; saved on a remote server and accessed via a network, shown as the processor 102 option 2 in FIG. 1, such as a cloud server; or a combination of a local and a remote processor 102, as required by the system 100. One skilled in the art will also appreciate that the processor 102 can include one or more processors and can process information and execute the various instructions or operations, as described herein. For example, the processor 102 can include a central processing unit (CPU), a microprocessor, a microcontroller, a system-on-a-chip, a digital signal processor (DSPs), field-programmable gate arrays (FPGAs), application-specific integrated circuits (ASICs), and/or a processor based on a multi-core processor architecture. One or more processors 102 can mean a single processor or multiple processors in a single processing unit, e.g., a central processing unit, or multiple processing units, e.g., a central processing unit and a graphics processing unit, or a central processing unit and a memory manager. The processor 102 can include multiple processors where one processor is capable of executing one or more of the elements described in this disclosure, and a subsequent processor or processors can execute other elements as described herein, capable of executing all elements only in combination. It should be understood that one or more of the processors 102 can be remote from the at least one local system server.

The memory 104 can be in communication with the processor 102 and can include both volatile and non-volatile memory 104 components. The memory 104 can store program instructions, operating software, and applications required for secure document processing operations. The memory 104 can include additional modules that work together to provide comprehensive management capabilities for domain name management and cross-ledger data synchronization. The memory 104 can implement secure memory handling, for example, cryptographic memory wiping after processing to ensure sensitive data does not persist in temporary storage. The memory 104 can store or otherwise include one or more databases 118. The memory 104 can include one or more memories and of any type suitable to the system 100 and can be implemented using any suitable volatile or nonvolatile data storage technology such as a semiconductor-based memory device, a magnetic memory device, an optical memory, a fixed memory, and/or a removable memory. For example, the memory 104 can include any combination of random-access memory (RAM), read only memory (ROM), static storage such as a magnetic or optical disk, a hard disk drive (HDD), or any other type of non-transitory machine or computer readable media.

As shown in FIG. 1, the interface module 106 can serve as an external layer and interface for the system 100 and the point of interaction between a user, the scheduler 116, and the system 100, interacting with hardware including various output devices that can display a representation of the interface module 106 for observation by the user, where such an output device can include, for example, one or more computer screens, speakers, tablet screens, television screens, smartphone screens, printers, or other view/audio ports. The interface module 106 can include, for example, a graphical user interface that can be displayed in various ways, for example, via a desktop application, smartphone, tablet, tv, mobile application, web interface, or API, and can interface with mobile short message service (SMS), social platforms, or messaging applications. The interface module 106 can be intuitive and user-friendly, for example, with custom user preferences and accessibility requirements, allowing the user to easily upload documents or data for later use, or allow the user to retrieve a generated or uploaded document or data.

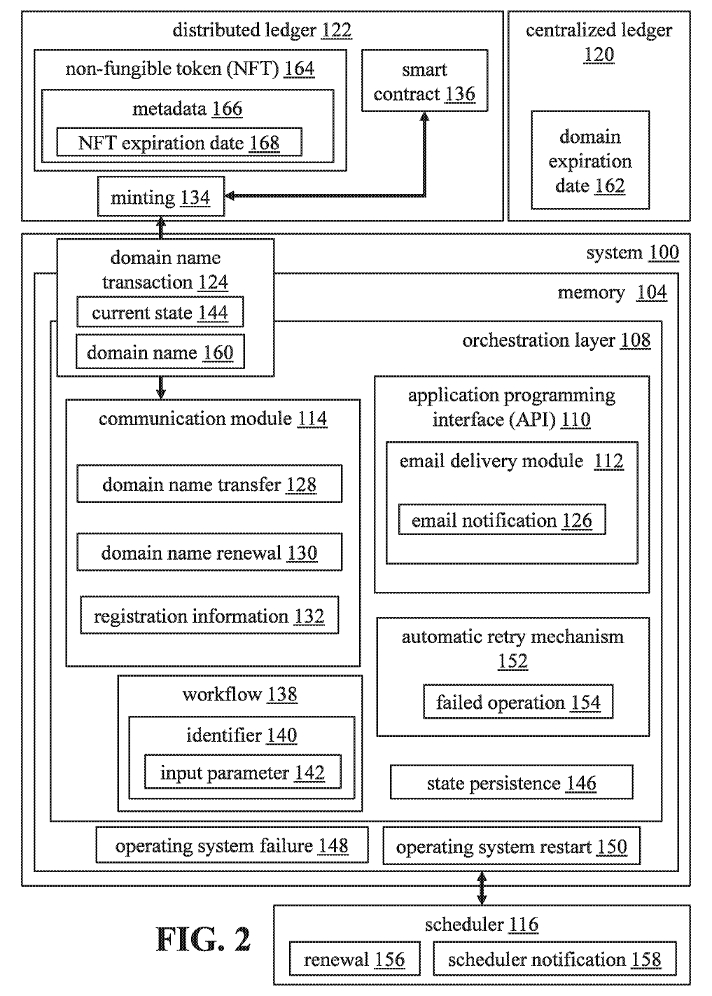

As shown in FIGS. 1-2, the orchestration layer 108 can be a software-based coordination component residing within the memory 104 and can manage domain name lifecycle operations, including domain name registration, importation, transfer, expiration updates, and automatic renewal, across the centralized ledger 120 and the distributed ledger 122. The orchestration layer 108 can receive a domain name transaction 124 via the API 110 and to execute a workflow 138 to synchronize the domain name transaction 124 with the centralized ledger 120 and the distributed ledger 122 via the communication module 114. For example, the orchestration layer 108 can be structured with nested workflows 138, where parent workflows 138 can be spawned to coordinate child workflows 138, enabling hierarchical structuring that breaks down complex operations into manageable units and supporting cohesive alignment of operations across expansive domain name transaction workflows 138. The orchestration layer 108 can support dynamic workflow modifications during runtime, using configuration parameters and activity proxying mechanisms, such that control structures including code loops and conditionals can cater to distinct ledger protocols and transaction scenarios. The orchestration layer 108 can implement comprehensive error monitoring and alert mechanisms, including fallback procedures, to maintain the integrity of the system 100 throughout domain name transaction processing, and can track the result of each workflow 138, including whether each workflow 138 can be a success, partial success, or failure.

As shown in FIGS. 1-2 and 4A-9, the API 110 can reside within the orchestration layer 108 and can be the point of interaction between the orchestration layer 108 and both the interface module 106 and the scheduler 116, through which domain name transactions 124 can be received and routed for further processing. For example, the domain name transaction 124 can be any operation relating to the lifecycle of a domain name 160, including registration, importation, transfer, renewal, or expiration update, and can be submitted by a user through the interface module 106 or triggered automatically by the scheduler 116, whereupon the domain name transaction 124 can be routed by the API 110 to the orchestration layer 108 for synchronization across the centralized ledger 120 and the distributed ledger 122. The API 110 can allow the user or the scheduler 116 to submit payment for registration, renewal, or automatic renewal of a domain name 160, and can execute a payment retry for a failed payment attempt, as well as to process a payment refund to the user according to the payment method chosen when a payment retry can be exhausted. The API 110 can, for example, offer a choice of payment methods to the user, including cryptocurrency, and can update the status of a domain name 160 order to reflect payment outcomes, including a failure or a successful payment, and to transmit appropriate notifications to the user via the email delivery module 112. It should be appreciated that the API 110 can include the email delivery module 112, through which an email notification 126 relating to the status of the domain name transaction 124 can be delivered to the user at any stage of the domain name lifecycle.

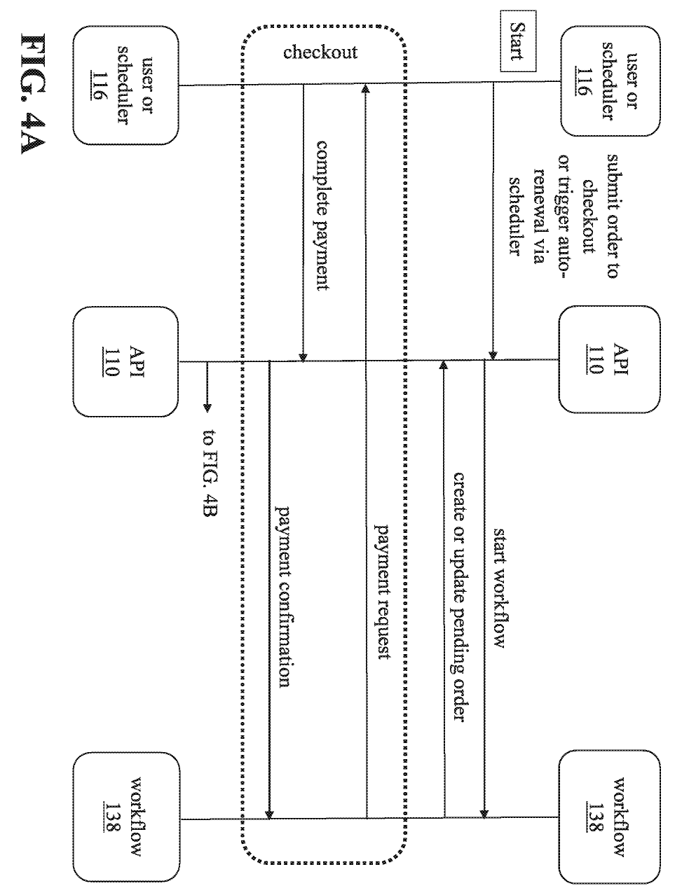

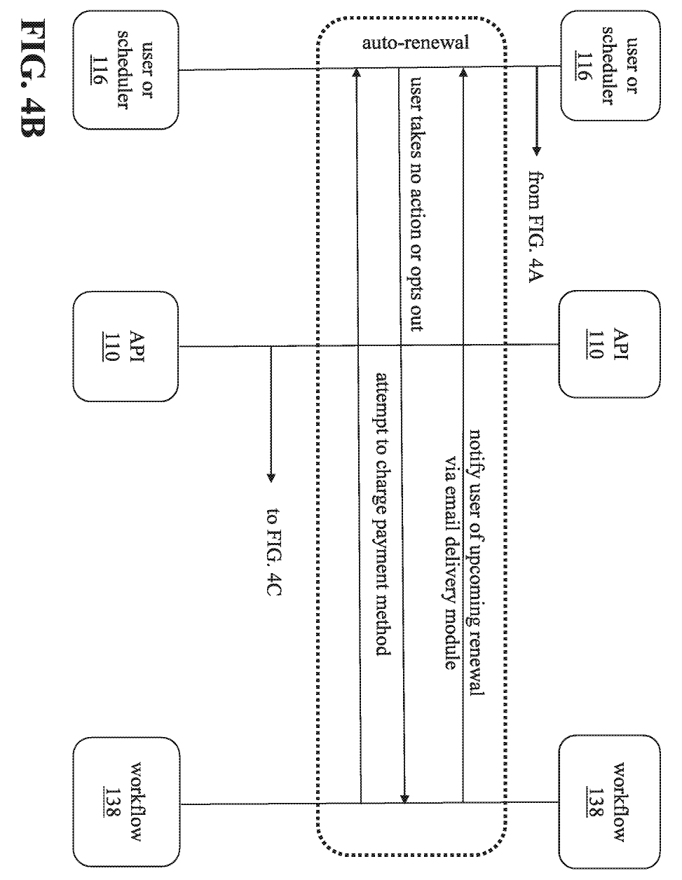

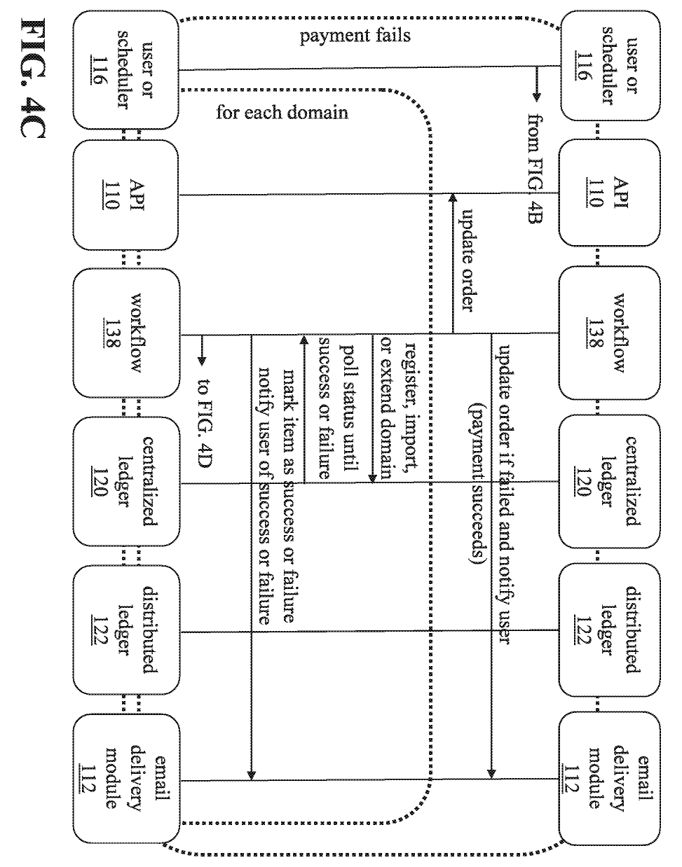

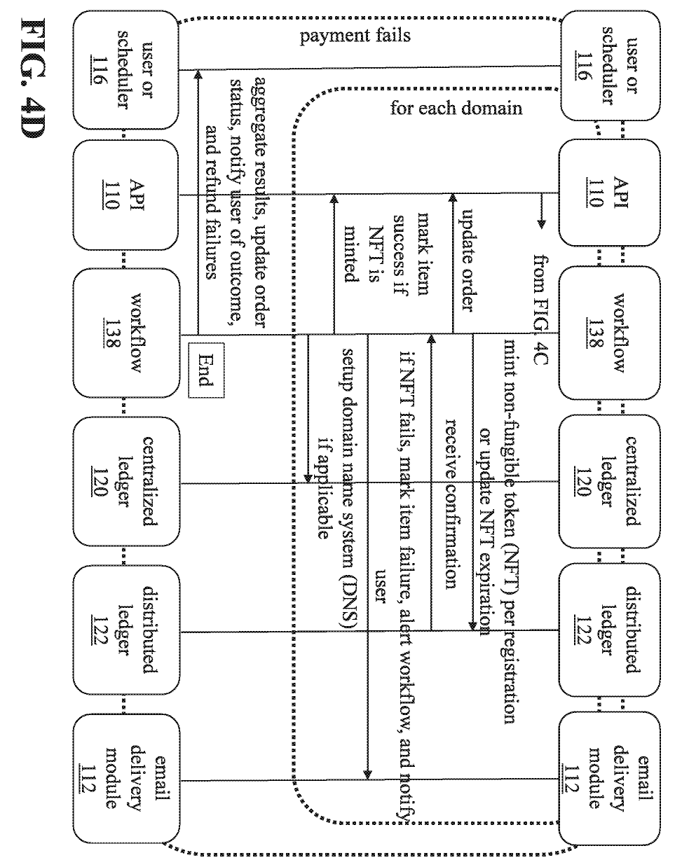

As shown in FIGS. 1 and 4C-4D, the email delivery module 112 can reside within or work in conjunction with the API 110 and can transmit an email notification 126 to the user relating to the status of a domain name transaction 124 across the centralized ledger 120 and the distributed ledger 122. For example, the email notification 126 can be a message delivered via email to the user and can be generated by the email delivery module 112 at any stage where a workflow process can be encountered with a failure, or optionally upon successful completion of a workflow process relating to the domain name transaction 124. The email notification 126 can also be related to payment status, including payment success or payment failure, and can be delivered to the user based on the current activity of the user on the interface module 106, ensuring that the user can be informed of the outcome of a payment submission or a payment retry. The email delivery module 112 can deliver an email notification 126 to the user upon successful renewal of a domain name 160, upon a failed registration or importation attempt, or upon any other lifecycle event requiring user attention, and can also deliver email notifications 126 on behalf of the scheduler 116 relating to upcoming renewal events. It should be appreciated that the email delivery module 112 can provide alerts related to the registration process at any stage where the process can be encountered with an unexpected condition, ensuring that the user can be informed of the status of the domain name transaction 124 throughout the domain name lifecycle.

The communication module 114 can serve as a bidirectional communication component residing within the orchestration layer 108 and can facilitate communication between the orchestration layer 108 and both the centralized ledger 120 and the distributed ledger 122, as shown in FIGS. 1-2. The communication module 114 can communicate with Internet Corporation for Assigned Names and Numbers (ICANN)-compliant domain name registrars through the Extensible Provisioning Protocol (EPP) and can also interact with smart contracts 136 on the distributed ledger 122 that implement non-fungible token (NFT) 164 standards. The communication module 114 can support two-way communication between active workflows 138 within the orchestration layer 108 and ledger systems through activity proxying mechanisms, allowing for real-time status tracking and coordination of domain name transactions 124 across both the centralized ledger 120 and the distributed ledger 122. The communication module 114 can, for example, support operation tracking and status polling, submitting operations to the centralized ledger 120 via the EPP and verifying completion before proceeding with related operations on the distributed ledger 122. The communication module 114 can synchronize domain name 160 status and identify and resolve inconsistencies between the centralized ledger 120 and the distributed ledger 122 through periodic reconciliation processes or audits executed by the orchestration layer 108.

As shown in FIGS. 1-2, the communication module 114 can coordinate a domain name transfer 128 where ownership of a domain name 160 can be transferred from one party to another through a process that spans both the centralized ledger 120 and the distributed ledger 122. During a domain name transfer 128, the communication module 114 can execute transfer operations through the centralized ledger 120 of a centralized domain name registrar, followed by executing transfer operations through the distributed ledger 122 to update the representation of the domain name 160 on a blockchain-based NFT 164 system, with the orchestration layer 108 maintaining consistency across both ledgers upon completion. A domain name renewal 130 can be a cross-ledger operation of the communication module 114 where the registration period of a domain name 160 can be extended through the centralized ledger 120, and the expiration information can be subsequently updated on the distributed ledger 122 to reflect the new domain expiration date 162. Upon successful completion of a domain name renewal 130, the communication module 114 can update the metadata 166 of the NFT 164 on the distributed ledger 122 to reflect the new domain expiration date 162, ensuring synchronization between the centralized ledger 120 and the distributed ledger 122. Both the domain name transfer 128 and the domain name renewal 130 can be managed by the communication module 114 in a manner that ensures data integrity and maintains consistent state across both the centralized ledger 120 and the distributed ledger 122, with the orchestration layer 108 tracking whether both ledgers can be in sync upon completion.

The communication module 114 can receive registration information 132, a collection of data associated with a domain name 160 from the centralized ledger 120 upon successful completion of a domain name registration or importation. The registration information 132 can be inclusive of the domain name 160 itself, the domain expiration date 162, the address of the owner, the chain identifier, and other descriptive information defining the properties and ownership of the domain name 160 on the centralized ledger 120. The registration information 132 can be received by the orchestration layer 108 via the communication module 114 from the centralized ledger 120 after a successful registration request can be submitted to a domain name registrar through the EPP. It should be understood that the orchestration layer 108, via the communication module 114, can synchronize the registration information 132 with metadata 166 of the NFT 164 across the centralized ledger 120 and the distributed ledger 122, ensuring that the ownership, status, and domain expiration date 162 of the domain name 160 can be consistent between both ledger types. The registration information 132 can be further used by the communication module 114 as the basis for minting 134 the NFT 164 on the distributed ledger 122, creating a verifiable, immutable on-chain representation of the domain name 160 with metadata 166 that mirrors the corresponding data on the centralized ledger 120.

The communication module 114 can mint the registration information 132 via the distributed ledger 122. Minting 134 can serve as the process by which a non-fungible token NFT 164 can be created and can serve as a blockchain-based representation of the domain name 160. In other words, the minting process 134 can be initiated by the orchestration layer 108 via the communication module 114 upon successful completion of a domain name registration or importation through the centralized ledger 120, ensuring that the distributed ledger 122 can be updated with an NFT 164 that accurately represents the domain name 160 and its registration information 132. For example, upon confirmation of an NFT 164 minting 134 or metadata 166 update operation on the distributed ledger 122, the communication module 114 can capture and record both the transaction hash and the block number associated with the on-chain transaction, with the block number serving as an additional data point alongside the transaction hash to verify the finality of blockchain-based domain name transactions 124 on the distributed ledger 122. The communication module 114 can trigger the execution of a smart contract 136 on the distributed ledger 122 to accomplish the minting 134 of the NFT 164, where the smart contract 136 can be a programmable, self-executing agreement deployed on the distributed ledger 122 that automates blockchain-based domain name transactions. For example, the smart contract 136 can include a verifiable, immutable ownership record on the distributed ledger 122, a unique identifier distinguishing the domain name 160, metadata 166 defining domain name properties, and any other information needed to accurately represent the domain name 160 on the blockchain. It should be appreciated that the minting process 134, via the smart contract 136, can ensure that the NFT 164 accurately mirrors the domain name registration information 132 from the centralized ledger 120, providing a cryptographically validated representation of the domain name 160 on the distributed ledger 122.

As shown in FIGS. 4A-9, the communication module 114 in conjunction with the orchestration layer 108 can initiate and maintain the workflow 138 as a persistent, repetitious execution architecture and can coordinate domain name 160 lifecycle operations across the centralized ledger 120 and the distributed ledger 122 through a series of defined activities and state transitions. For example, the workflow 138 can be structured with clear start and end states, and can maintain a current status designation, such as "running," "completed," or "failed," and can track the result of each operation, including whether the operation can be a success, partial success, or failure for a given domain name transaction 124. The workflow 138 can track whether the centralized ledger 120 and the distributed ledger 122 can be in sync, out of sync, or pending sync for a given domain name registration, import, transfer, or renewal, providing the orchestration layer 108 with a comprehensive view of cross-ledger synchronization status. The workflow 138 can be based on defined business logic rules or algorithms designed to execute synchronization across the centralized registrar and the distributed registrar for registration, renewal, automatic renewal, or expiration updates of domain names 160, and can support dynamic modifications during runtime through configuration parameters. It should be appreciated that the workflow 138 can also support long-running operations extending across multiple years, enabling the orchestration layer 108 to manage domain name lifecycle events from initial registration through subsequent renewals without loss of state or operational continuity.

As shown in FIG. 1, the communication module 114 in conjunction with the orchestration layer 108 can utilize an identifier 140, a unique operation identifier associated with each workflow 138 execution within the orchestration layer 108. The identifier 140 can implement an idempotent workflow, e.g., performing an operation that produces the same result whether executed once or multiple times, across the centralized ledger 120 and the distributed ledger 122, ensuring that each domain name transaction 124 can be handled without duplication or inconsistency. The identifier 140 can, for example, include an input parameter 142 of the domain name transaction 124, where the input parameter 142 can be a deterministic value derived from the specific inputs of the domain name transaction 124, such as the domain name 160, the address of the user, the chain identifier, and the duration of the registration. The input parameter 142 can, for example, be a basis for generating the identifier 140 in a deterministic manner, such that the same domain name transaction 124, when submitted multiple times, can produce the same identifier 140 and therefore achieve the same intended effect without creating duplication on the centralized ledger 120 or the distributed ledger 122. The communication module 114 in conjunction with the orchestration layer 108 can initialize an idempotent workflow execution using the identifier 140, so that each workflow 138 can be uniquely identifiable and that repeated submissions of the same domain name transaction 124 can be managed without generating duplicate operations across the centralized ledger 120 and the distributed ledger 122. It should be appreciated that the identifier 140, when used in idempotent workflow execution, can allow transactional operations to remain deterministic across ledgers, supporting the integrity and consistency of domain name transactions 124 and allowing the orchestration layer 108 to verify the current state 144 before any modification can be undertaken.

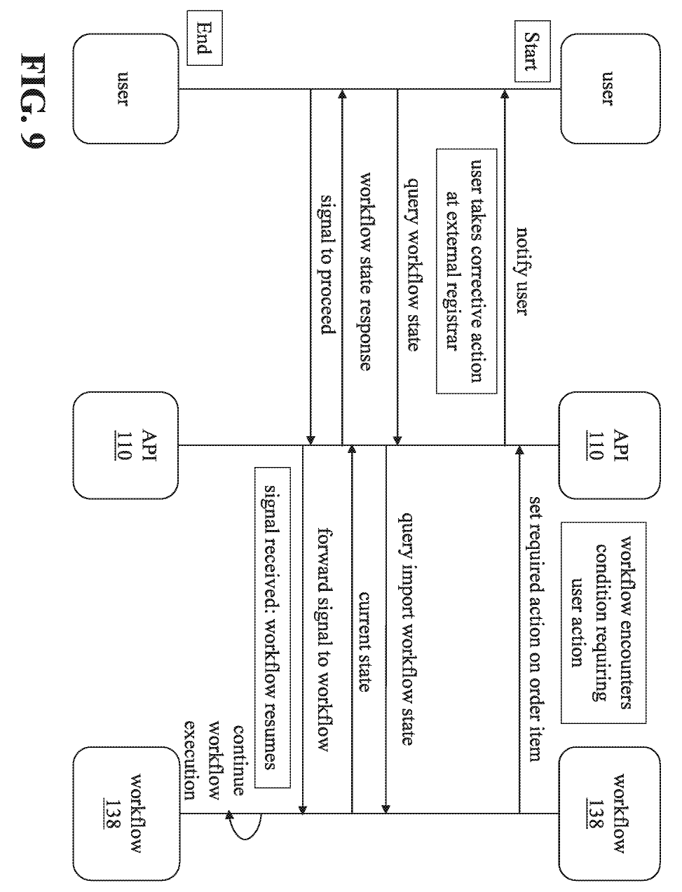

As shown in FIGS. 2 and 9, the communication module 114 in conjunction with the orchestration layer 108 can track a current state 144, e.g., a real-time status representation of a domain name transaction 124, as maintained by the orchestration layer 108 via the workflow 138, reflecting the synchronization status of the domain name 160 across the centralized ledger 120 and the distributed ledger 122 at any point in time. The orchestration layer 108 can verify the current state 144 based on the identifier 140, encompassing operational states such as "in sync," "out of sync," or "pending sync" before attempting modifications to either ledger, enabling informed decisions about retrying operations, compensating for failures, or proceeding to the next step in the workflow 138. State persistence 146 can be a capability of the orchestration layer 108 whereby the workflow 138 can maintain its operational state across executions, allowing the workflow 138 to pause, resume, and retry without loss of state information, ensuring that in-progress domain name transactions 124 can be recovered and completed without requiring resubmission, and supporting auditability by maintaining a record of workflow 138 execution states throughout long-running domain name lifecycle operations.

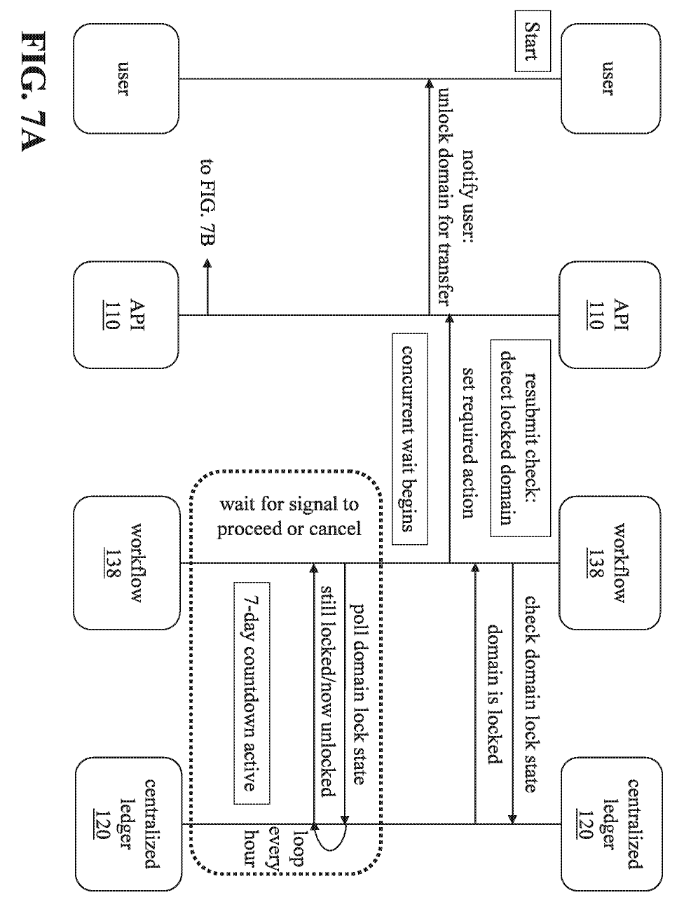

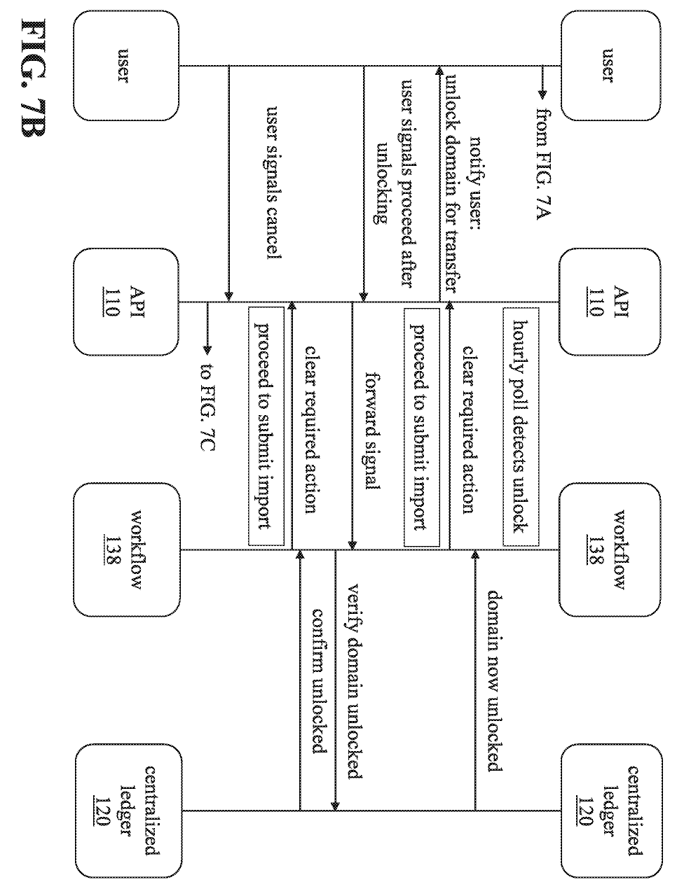

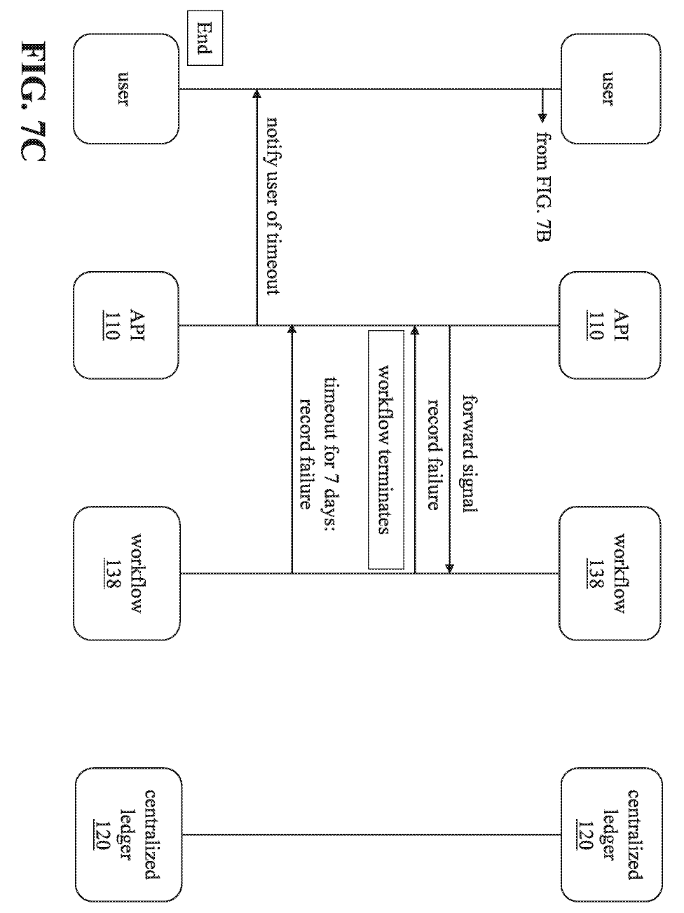

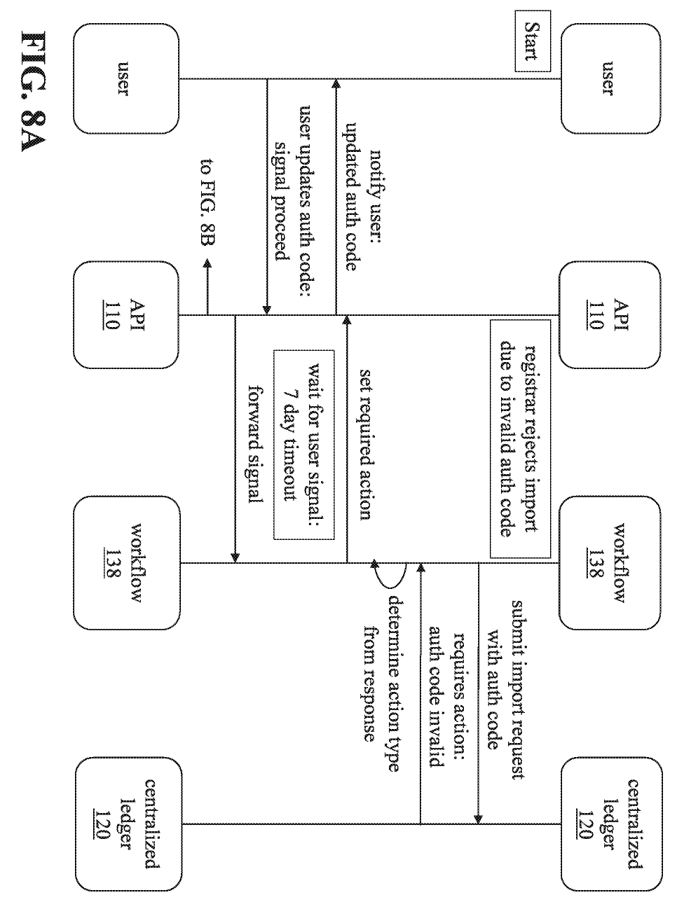

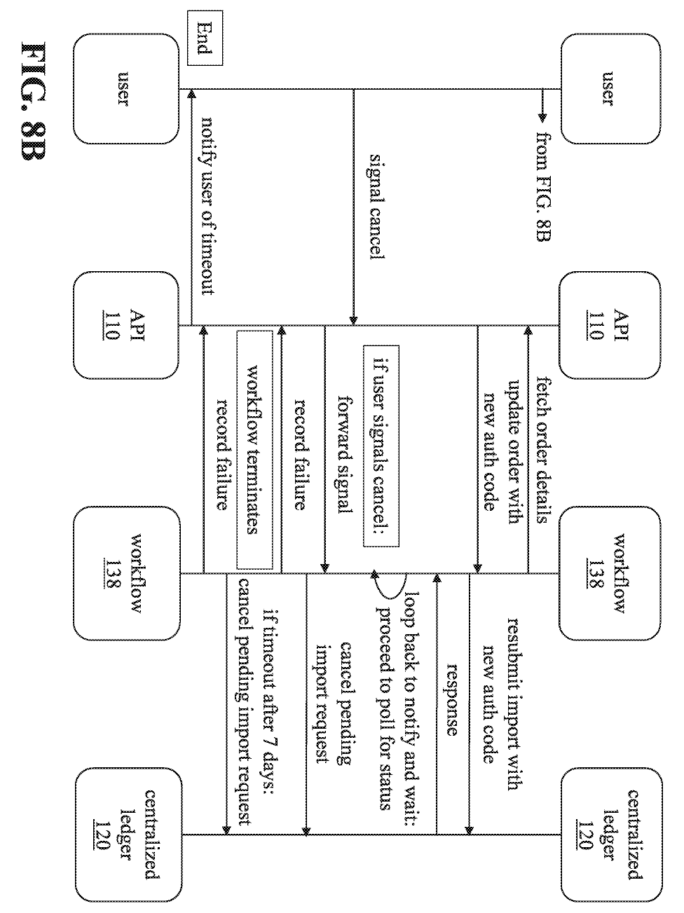

As shown in FIG. 1, the communication module 114 in conjunction with the orchestration layer 108 can maintain state persistence 146 across workflow 138 executions in the event of an operating system failure 148 or an operating system restart 150, allowing domain name transactions 124 to resume from their last known state without restarting from the beginning, preserving consistency across both the centralized ledger 120 and the distributed ledger 122. As shown in FIGS. 7A-8B, the orchestration layer 108 can also employ an automatic retry mechanism 152 to re-execute a failed operation 154, including operations affected by network errors, ledger unavailability, or smart contract execution errors without manual intervention, utilizing defined retry strategies, compensating transactions, fallback procedures, predictive analytics, and child workflows 138 to maintain transactional integrity across both ledgers.

As shown in FIGS. 1-2 and 4A-4D, the scheduler 116 can serve as a time-based triggering component residing within the memory 104 and can initiate automated domain name operations based on predefined schedules or temporal events associated with domain name lifecycle management. For example, the scheduler 116 can trigger a renewal 156 of a domain name 160 associated with a domain name transaction 124 and send a scheduler notification 158 based on the renewal 156 to the communication module 114, which can relay the scheduler notification 158 to the user via the email delivery module 112. The scheduler 116 can schedule domain name expiration checks, whereby the scheduler 116 can initiate the automatic renewal 156 of a domain name 160 as determined by an authorized user and can adjust the scheduling parameters based on the domain expiration date 162 of each domain name 160 on the centralized ledger 120. The scheduler 116 can be implemented using, for example, Linux^{®}-based schedulers such as Cron or SystemD, Windows^{®}-based schedulers such as Task Scheduler, or other equivalent time-based execution systems, all of which can trigger scheduled processes within the system 100. The scheduler 116 can also initiate an audit workflow 138 to identify, through an iterative search, which domain names 160 on the centralized ledger 120 can be due for renewal, enabling the automatic renewal process for each domain name 160 whose domain expiration date 162 can be within a defined proximity to expiration.

As shown in FIGS. 4A-4D, the scheduler 116 can trigger a renewal 156, an automated domain name lifecycle operation, and can extend the registration period of a domain name 160 associated with a domain name transaction 124 on the centralized ledger 120, followed by updating the metadata 166 of the corresponding NFT 164 on the distributed ledger 122 to reflect the new domain expiration date 162. The renewal 156 can be triggered by the scheduler 116, for example, based on the proximity of the domain expiration date 162 of the domain name 160 to an expiration threshold, and the scheduler 116 can send the domain name 160, the owner address, and the duration in years to the orchestration layer 108 to initiate the corresponding renewal workflow 138. In another example, the renewal 156 process can be arranged such that the orchestration layer 108 can submit a renewal operation to the communication module 114 for transmission to the domain name registrar on the centralized ledger 120, and upon successful renewal, the workflow 138 can retrieve the new expiration time and update the domain expiration date 162 on the distributed ledger 122 via a child workflow 138. The scheduler 116 can also initiate, for example, a discrete expiration check event, triggering a dedicated verification pass across the centralized ledger 120 to assess the domain expiration date 162 of domain names 160 independently of and without initiating a renewal 156 operation. One of ordinary skill in the art would understand that the scheduler notification 158 under the scheduler 116 can be an alert or status message generated and sent by the scheduler 116 to the communication module 114 and subsequently delivered to the user via the email delivery module 112, relating to the outcome of a renewal 156 or an upcoming renewal 156 event. It should be understood that the scheduler notification 158 can be transmitted by the scheduler 116 to inform the user of an upcoming renewal 156 event prior to the domain expiration date 162, allowing the user to take action when automatic renewal 156 can be undesired, or to confirm that the renewal 156 process on both the centralized ledger 120 and the distributed ledger 122 can be completed successfully.

As shown in FIG. 1, the database 118 can store domain name transaction 124 data, registration information 132, workflow 138 execution states, and other data associated with the management of domain name lifecycle operations across the centralized ledger 120 and the distributed ledger 122. The database 118 can include a local database, shown as the database 118 option 1 in FIG. 1, saved on a remote server and accessed via a network, shown as the database 118 option 2 in FIG. 1, such as a cloud server; or a combination of a local and a remote database 118, as required by the system 100. The database 118 can also include, for example, a vector database 118 or vector store for storing vectors, initialization vectors (IVs), feature vectors, or vector embeddings, e.g. flexible, meaning-based, probabilistic numerical representations of data that capture semantic meaning, allowing the system 100 to compare similarities between different types of data. The database 118 can also include a relational database 118, for example, data saved in a structured form, e.g. a structured query language (SQL) table, a comma-separated values (CSV) file, or in JavaScript object notation (JSON), or a JSON-related object or map, or object storage, or other forms of tabular input. The database 118 can also include a general storage database 118 to store, for example, unstructured data such as HTML, text, raw transcripts, chat logs, images, audio files, or social media posts. The database 118 can save documents and sensitive data, for example, on the blockchain for immutable document history, and integrate with smart contract platforms for automated transactional events. It should be understood that the database 118 can employ separate or secondary encryptions as needed to protect sensitive information, ensuring that the stored data remains secure and confidential when later retrieved by the user.

As shown in FIGS. 1-3 and 4C-8B, the centralized ledger 120 can include a domain name registration system managed by a centralized authority and can store and manage domain name registrations, transfers, and renewals through established registrar protocols. For example, the centralized ledger 120 can be held by an internet domain name registrar, such as a Cloudflare^{®} internet domain name registrar, Verisign^{®} internet domain name registrar, GoDaddy^{®} internet domain name registrar, or IONOS^{®} internet domain name registrar, or any other ICANN-compliant registrar, and can use DNS records to connect the domain name 160 with email, websites, and other web services through the DNS. The centralized ledger 120 can communicate with the orchestration layer 108 via the communication module 114 through the EPP, allowing the system 100 to submit registration requests, transfer requests, and renewal requests to the centralized domain name registrar and to receive status confirmations in response. The domain name 160 can be a human-readable identifier associated with an IP address on the centralized ledger 120 and can be the primary asset managed by the system 100 across both the centralized ledger 120 and the distributed ledger 122 throughout the domain name lifecycle. For example, the centralized ledger 120 can store the domain name 160 together with associated registration details, including the information of the owner, assigned IP addresses, and the domain expiration date 162 of the domain name 160, all of which can be accessible to the orchestration layer 108 via the communication module 114.

The centralized ledger 120 can include a domain expiration date 162, e.g., data field associated with the domain name 160 on the centralized ledger 120, representing the date upon which the registration of the domain name 160 can be due to expire absent a subsequent renewal, and can be a component of the registration information 132 that the orchestration layer 108 can retrieve via the communication module 114. For example, the domain expiration date 162 can be used by the scheduler 116 to determine when a renewal 156 operation can be due and can be used as a basis for triggering automated renewal workflows 138 and scheduler notifications 158 prior to the expiration of the domain name 160 on the centralized ledger 120. Upon successful completion of a domain name renewal 130, the orchestration layer 108 can synchronize the updated domain expiration date 162 across the centralized ledger 120 and the distributed ledger 122, ensuring that the domain expiration date 162 on the centralized ledger 120 can be consistent with the NFT expiration date 168 reflected in the metadata 166 of the NFT 164 on the distributed ledger 122. The domain expiration date 162 on the centralized ledger 120 can be a foundational element for cross-ledger synchronization, serving as the authoritative source of expiration data that the orchestration layer 108 can propagate to the distributed ledger 122 upon completion of each renewal 156 operation. One of ordinary skill in the art would understand that the orchestration layer 108 can maintain synchronization of the domain expiration date 162 by updating the NFT 164 metadata 166 on the distributed ledger 122 whenever a change to the domain expiration date 162 on the centralized ledger 120 is confirmed as complete through the communication module 114.

As shown FIGS. 1-3 and 4C-6, the distributed ledger 122 can include a decentralized network-based record-keeping system operable to allow simultaneous access, validation, and record updating across a networked infrastructure, and can utilize cryptographic verification to ensure that domain name transactions 124 can be secure and immutable. The distributed ledger 122 can be held by a blockchain-based NFT system, for example, blockchain platforms including Ethereum’s^{®} EthereumName Service^{®} (ENS) blockchain-based system, Emercoin’s^{®} EmerDNS^{®} blockchain-based system, or other systems utilizing distributed ledger technologies (DLTs), and can utilize smart contracts 136 for the automation of blockchain transactions. For example, a non-fungible token NFT 164 can include a unique, cryptographically secured digital asset on the distributed ledger 122 and can represent a domain name 160 on the blockchain, providing a decentralized, immutable record of domain name ownership that can be synchronized with the centralized ledger 120 by the orchestration layer 108. The NFT 164 on the distributed ledger 122 can be created by the communication module 114 via the execution of a smart contract 136, where the NFT 164 can be inclusive of the registration information 132 received from the centralized ledger 120, such as the domain name 160, the address of the owner, and the NFT expiration date 168. It should be appreciated that the distributed ledger 122 can provide a cryptographically validated ownership record where the NFT 164 data is synchronized with the centralized ledger 120 upon the successful completion of any domain name transaction 124, allowing for consistency across both ledger systems.

The distributed ledger 122 can include metadata 166, e.g., descriptive data associated with the NFT 164 on the distributed ledger 122. In other words, the metadata 166 can include information defining the properties of the domain name 160 represented by the NFT 164, such as the domain name 160 itself, the address of the owner, the chain identifier, and the NFT expiration date 168 of the domain name registration. The NFT expiration date 168 can be, for example, a data field within the metadata 166 of the NFT 164 on the distributed ledger 122, representing the date upon which the domain name registration, as reflected on the distributed ledger 122, can be set to expire, and can serve as a synchronized counterpart to the domain expiration date 162 of the domain name 160 on the centralized ledger 120. It should be appreciated that the NFT expiration date 168 in the metadata 166 can be synchronized with the domain expiration date 162 of the domain name 160 on the centralized ledger 120 by the orchestration layer 108, allowing the same expiration information to be reflected across both the centralized ledger 120 and the distributed ledger 122. Upon successful completion of a domain name renewal 130, the orchestration layer 108 can update the NFT expiration date 168 in the metadata 166 of the NFT 164 on the distributed ledger 122 via the communication module 114 and the smart contract 136, reflecting the updated domain expiration date 162 from the centralized ledger 120 in the NFT 164. It should also be appreciated that the metadata 166 can include a unique identifier distinguishing the domain name 160 and can be an on-chain data structure that maintains a consistent and verifiable record of the domain name 160 status, providing a transparent and immutable representation of domain name properties on the distributed ledger 122 that is validated through cryptographic verification.

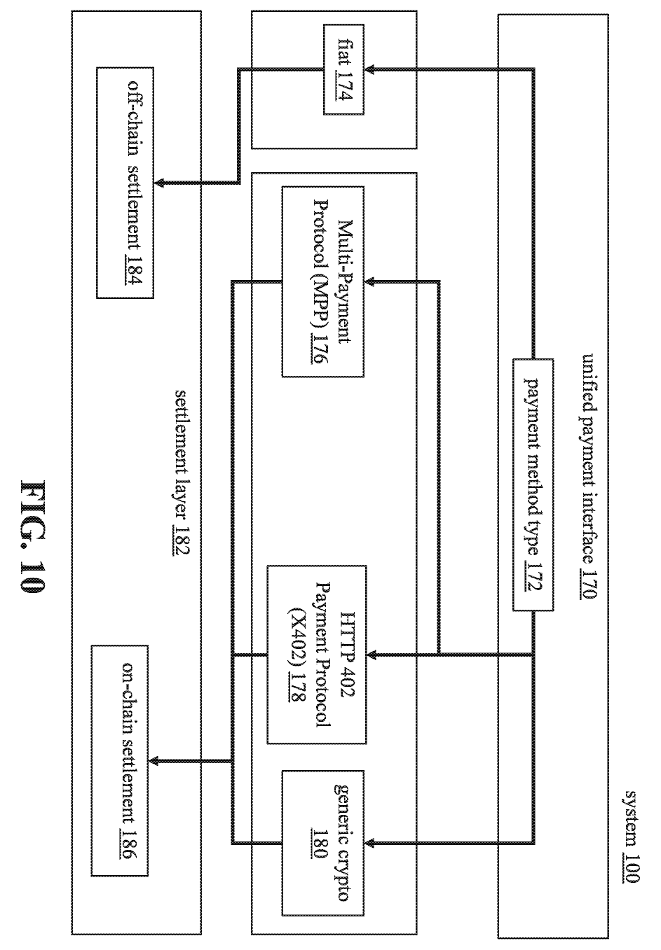

As shown in FIG. 10, a payment protocol hierarchy of the system 100 can be organized around a unified payment interface 170 that accepts payment method types 172 classified as either fiat 174 or crypto. The payment method type 172 can be implemented, for example, as a structured payment method object carrying a category designation and, for crypto payments, an optional protocol field that identifies the specific crypto payment protocol in use. Under the crypto category, three protocol-specific processors can be supported: a multi-payment protocol (MPP) 176, a HTTP 402 payment protocol (X402) 178, and a generic crypto 180 processor, each of which can be routed to on-chain settlement 186 within the settlement layer 182 through blockchain transaction confirmation. The fiat 174 payment type can be routed to off-chain settlement 184 within the settlement layer 182 through a payment gateway operating outside the blockchain. The settlement layer 182 advantageously encompasses both off-chain settlement 184 and on-chain settlement 186 as distinct resolution paths, with the path determined by the payment method type 172 associated with a given cross-ledger domain operation of the system 100.

The system 100 can include a non-transitory computer-readable medium 200 operable to store processor instructions 202 for managing the domain name transaction 124 for the user across the centralized ledger 120 and the distributed ledger 122, as shown in FIG. 1. When the processor instructions 202 can be executed by the processor 102, the processor instructions 202 can cause the processor 102 to receive, via the API 110 of the orchestration layer 108, the domain name transaction 124 from the user. The processor instructions 202 can cause the processor 102 to send, via the communication module 114 of the orchestration layer 108, the domain name transaction 124 to the centralized ledger 120. The processor instructions 202 can cause the processor 102 to receive, via the communication module 114, registration information 132 from the centralized ledger 120. The processor instructions 202 can cause the processor 102 to mint, via the communication module 114, an NFT 164 on the distributed ledger 122, the NFT 164 including the registration information 132. The processor instructions 202 can cause the processor 102 to synchronize the registration information 132 with metadata 166 of the NFT 164 across the centralized ledger 120 and the distributed ledger 122.

As shown in FIGS. 12A and 12B, a method 300 for managing the domain name transaction 124 for the user across the centralized ledger 120 and the distributed ledger 122 is provided. The method 300 can include a step 302 of providing the system 100 for managing the domain name transaction 124 for the user across the centralized ledger 120 and the distributed ledger 122 described herein above. The method 300 can include a step 304 of receiving, via an API 110, the domain name transaction 124 from the user. The method 300 can include a step 306 of sending, via the communication module 114, the domain name transaction 124 to the centralized ledger 120. The method 300 can include a step 308 of receiving, via the communication module 114, registration information 132 from the centralized ledger 120. The method 300 can include a step 310 of minting 134, via the communication module 114, an NFT 164 on the distributed ledger 122, the NFT 164 including the registration information 132. The method 300 can include a step 312 of synchronizing the registration information 132 with metadata 166 of the NFT 164 across the centralized ledger 120 and the distributed ledger 122.

As shown in FIG. 13, a method 400 for managing the domain name transaction 124 for the user across the centralized ledger 120 and the distributed ledger 122 via idempotent workflow execution and state persistence 146 is provided. The method 400 can include steps 302-312 of method 300 (as steps 402-412 respectively). The method 400 can include a step 414 of initializing, via an orchestration layer 108, an idempotent workflow execution with an identifier 140, the identifier 140 including an input parameter 142 of the domain name transaction 124. The method 400 can include a step 416 of verifying, via the orchestration layer 108, the current state 144 of the domain name transaction 124 across the centralized ledger 120 and the distributed ledger 122 based on the identifier 140. The method 400 can include a step 418 of maintaining, via the orchestration layer 108, state persistence 146 across the workflow 138 execution upon an occurrence of an operating system failure 148, an operating system restart 150, or both. The method 400 can include a step 420 of synchronizing, via the orchestration layer 108, an domain expiration date 162 of the domain name 160 across the centralized ledger 120 and the distributed ledger 122 upon successful completion of the domain name renewal 130, where the domain expiration date 162 on the centralized ledger 120 can be reflected as an NFT expiration date 168 in metadata 166 of the NFT 164 on the distributed ledger 122.

As shown in FIG. 14, a method 500 for managing the domain name transfer 128, the domain name renewal 130, and the minting 134 of an NFT 164 via the smart contract 136 for the domain name transaction 124 for the user across the centralized ledger 120 and the distributed ledger 122 can be provided. The method 500 can include steps 302-308 of method 300 (as steps 502-508 respectively). The method 500 can include a step 510 of executing, via the communication module 114, the domain name transfer 128 or the domain name renewal 130 for the domain name 160 associated with the domain name transaction 124 across the centralized ledger 120 and the distributed ledger 122. The method 500 can include a step 512 of 120. The method 500 can include steps 310-312 of method 300 (as steps 514-516 respectively).

As shown in FIG. 15, a method 600 for managing the domain name transaction 124 for the user across the centralized ledger 120 and the distributed ledger 122 via an interface module 106, an email delivery module 112, and the scheduler 116 is provided. The method 600 can include steps 302-312 of method 300 (as steps 602-612 respectively). The method 600 can include a step 614 of receiving, via an interface module 106, the domain name transaction 124 from the user. The method 600 can include a step 616 of routing, via the interface module 106, the domain name transaction 124 to the API 110 of the orchestration layer 108. The method 600 can include a step 618 of transmitting, via an email delivery module 112, the email notification 126 to the user relating to the status of the domain name transaction 124 across the centralized ledger 120 and the distributed ledger 122. The method 600 can include a step 620 of triggering, via the scheduler 116, the renewal 156 of the domain name 160 associated with the domain name transaction 124. The method 600 can include a step 622 of sending the scheduler notification 158 based on the renewal 156 to the communication module 114.

The present technology can advantageously provide a solution to interoperability gaps and operational limitations associated with managing digital assets across centralized and distributed ledger systems. The present technology can resolve the siloed nature of centralized architectures, the incompatibility between centralized protocol-based verification methods and blockchain-based cryptographic validation mechanisms, and the redundant administrative workflows required when managing assets across disparate systems. Manual reconciliation processes and centralized bridging solutions, which can be sources of data inconsistency, operational overhead, and single points of failure, can be replaced by a persistent, automated workflow architecture that can be designed to maintain state and data integrity across both ledger types. Error conditions that can arise during asset import or transfer operations such as transfer locks or authorization failures can be communicated to the user in a timely manner, allowing corrective action to be taken without abandoning the workflow entirely. Additionally, the limitations of payment processing systems that can be restricted to a single payment modality can be addressed by support for both fiat and multiple cryptocurrency payment protocols within a single unified interface. Taken together, these capabilities can be a more reliable, interoperable, and user-responsive approach to cross-ledger digital asset management than what can be found in certain earlier systems.

### EXAMPLES

Example embodiments of the present technology are provided with reference to the several figures including FIGS. 1-15 enclosed herewith.

Example 1: Cross-Ledger Domain Registration, Auto-Renewal, and NFT Minting via Checkout Workflow

As shown in FIGS. 4A-4D, an example of a domain name transaction 124 managed by the system 100 across a centralized ledger 120 and a distributed ledger 122 is provided. The system 100 can process a domain name transaction 124 from initial order submission through payment, domain registration or renewal on the centralized ledger 120, and non-fungible token NFT 164 minting 134 or metadata 166 update on the distributed ledger 122, with each stage coordinated by the orchestration layer 108 via a persistent workflow 138.

As shown in FIG. 4A, the workflow 138 can be initiated when a user or the scheduler 116 submits an order to checkout or triggers an auto-renewal via the scheduler 116. The API 110 can be the point of entry for the domain name transaction 124, and upon receipt, the workflow 138 can be started by the orchestration layer 108. A pending order can be created or updated by the workflow 138, and a payment request can be transmitted to the user through the API 110. Upon completion of the checkout process, payment can be confirmed, and the workflow 138 can be advanced to the stage shown in FIG. 4B.

As shown in FIG. 4B, where the domain name transaction 124 can be an auto-renewal triggered by the scheduler 116, the workflow 138 can notify the user of an upcoming renewal 156 via the email delivery module 112. If the user takes no action or opts out, the workflow 138 can be operable to proceed by attempting to charge the payment method on file. The scheduler notification 158 generated by the scheduler 116 can be relayed to the user through the email delivery module 112 prior to the renewal 156, allowing the user to take action should the automatic renewal 156 be undesired, and the workflow 138 can then be advanced to the stage shown in FIG. 4C.

As shown in FIG. 4C, upon receipt of a payment outcome, the workflow 138 can process the domain name transaction 124 across the centralized ledger 120 and the distributed ledger 122. Should payment be unsuccessful, the order can be updated to reflect the failed payment status, and the user can be notified of the failure via the email delivery module 112. Upon a successful payment, the order can be updated accordingly, and the workflow 138 can be operable to initiate a register, import, or extend domain operation on the centralized ledger 120 for each domain name 160 associated with the domain name transaction 124. The workflow 138 can poll the status of each operation on the centralized ledger 120 until a success or failure response can be received, and each domain name 160 can be marked as a success or failure accordingly. Upon reaching a status determination for each domain name 160, the user can be notified of the outcome via the email delivery module 112, and the workflow 138 can be advanced to the stage shown in FIG. 4D.

As shown in FIG. 4D, upon successful completion of operations on the centralized ledger 120, the workflow 138 can mint an NFT 164 per registration or update the NFT expiration date 168 within the metadata 166 of an existing NFT 164 on the distributed ledger 122 for each domain name 160. The communication module 114 can be operable to trigger execution of the smart contract 136 on the distributed ledger 122 to accomplish the minting 134 or the metadata 166 update, and upon receipt of a blockchain confirmation, each domain name 160 can be marked as a success where the NFT 164 can be confirmed as minted or updated. Should the minting 134 or metadata 166 update process encounter a failure, the failed operation 154 can be flagged, the workflow 138 can be alerted to the failure condition, and the user can be notified via the email delivery module 112. Where applicable, the domain name system DNS can be set up for each domain name 160 upon successful NFT 164 confirmation on the distributed ledger 122. Upon completion of all operations across the centralized ledg112 and the distributed ledger 122, the workflow 138 can aggregate the results, update the overall order status, notify the user of the outcome via the email delivery module 112, and process refunds for any failed domain name 160 items. The workflow 138 can then be brought to an end state, providing a complete cross-ledger domain name transaction 124 outcome spanning both the centralized ledger 120 and the distributed ledger 122.

Example 2: Complete Interactive Workflow with Lock State Verification

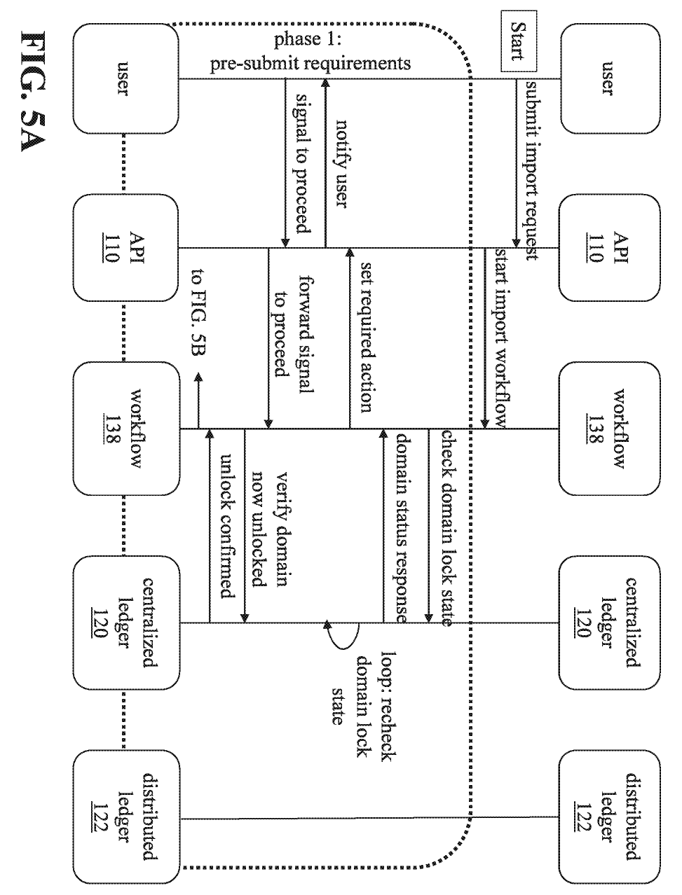

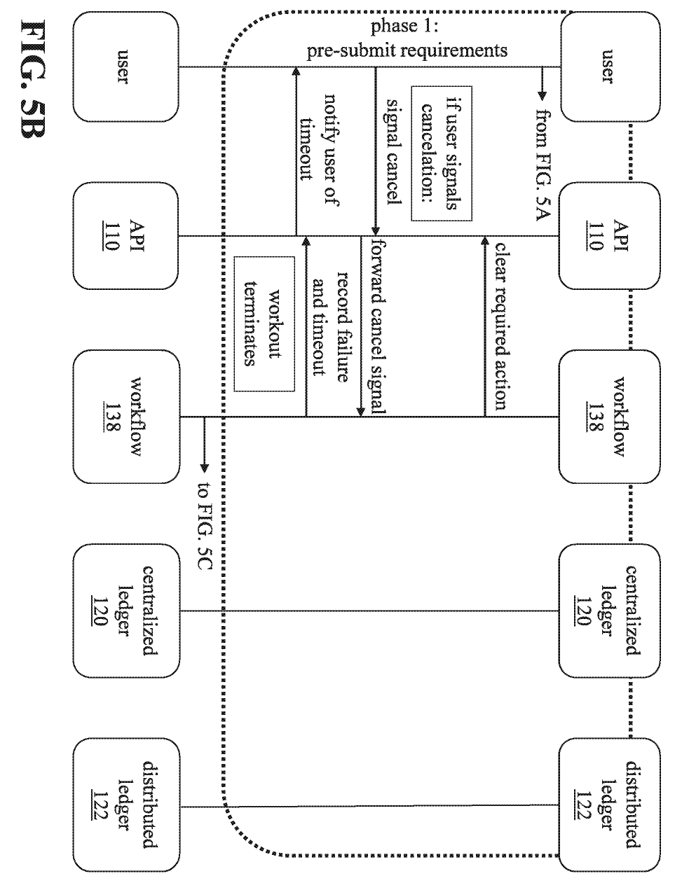

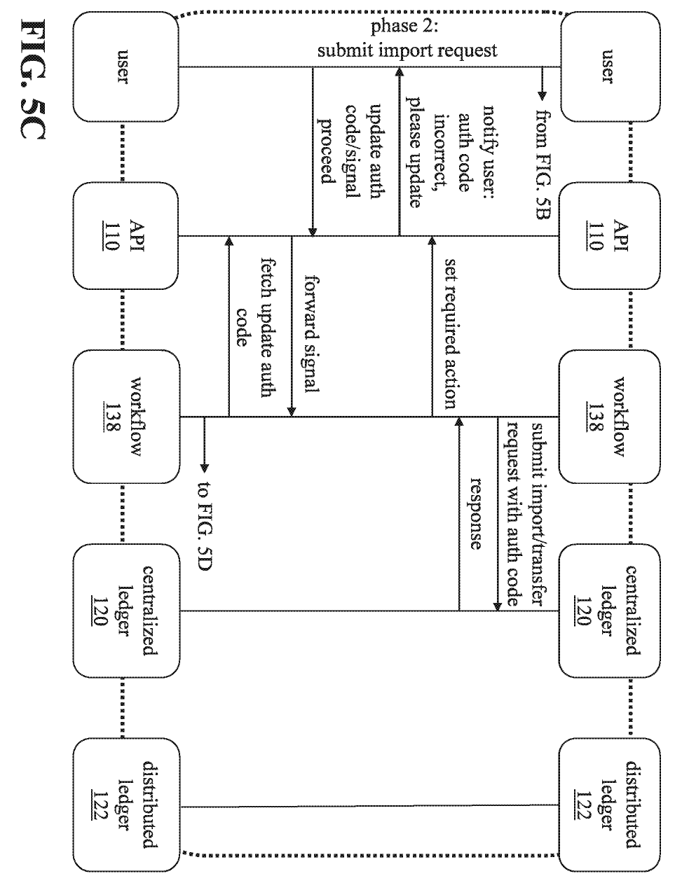

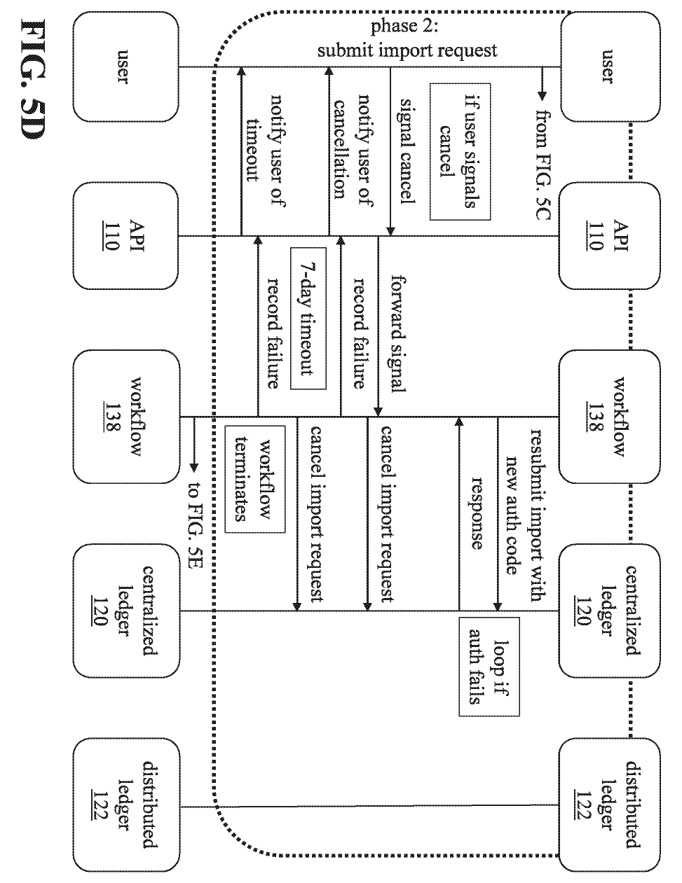

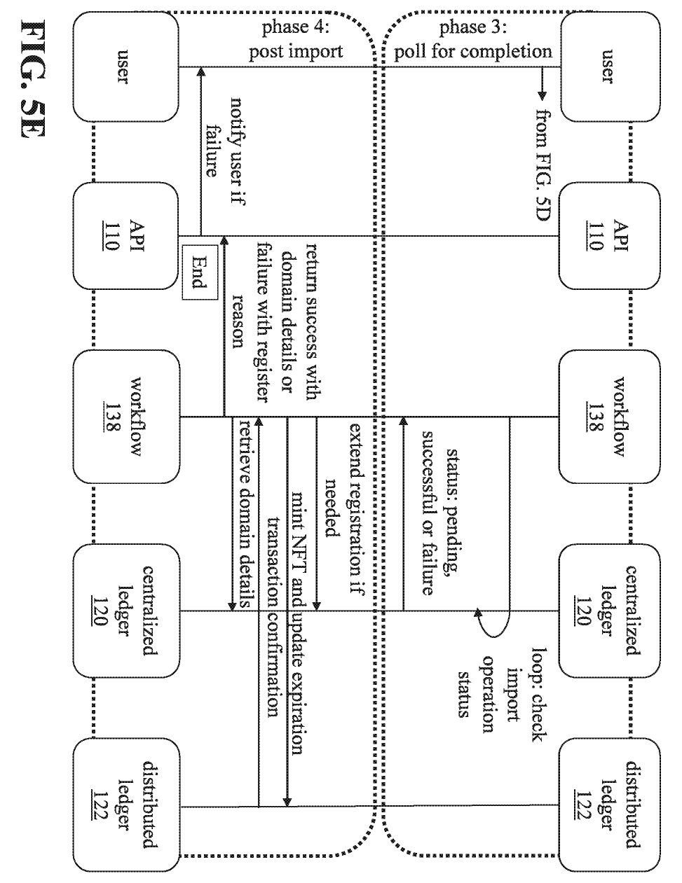

As shown in FIGS. 5A-5E, an example of a domain name import operation managed by the system 100 across a centralized ledger 120 and a distributed ledger 122 is provided. The workflow 138 for domain name import can be organized into four sequential phases: pre-submit requirements verification, import request submission with auth code validation, status polling, and post-import processing. Each phase can be coordinated by the orchestration layer 108 via the API 110, with cross-ledger synchronization completed upon successful minting 134 of a non-fungible token NFT 164 on the distributed ledger 122.

As shown in FIG. 5A, Phase 1 for pre-submit requirements can be initiated when a user submits an import request via the API 110, whereupon the workflow 138 can be started by the orchestration layer 108 to manage the domain name import operation. The workflow 138 can check the lock state of the domain name 160 on the centralized ledger 120 to verify that the domain name 160 can be in a transferable state prior to submission. A domain status response can be returned by the centralized ledger 120, and where the domain name 160 can be found to be in a locked state, the workflow 138 can be operable to set a required action and notify the user via the email delivery module 112 of the need to unlock the domain name 160 for transfer. A loop can be established by the workflow 138 to periodically recheck the lock state of the domain name 160 on the centralized ledger 120 until the user provides a signal to proceed. Upon receipt of that signal, the workflow 138 can be operable to forward the signal and verify with the centralized ledger 120 that the unlock can be confirmed.

As shown in FIG. 5B, upon confirmation that the domain name 160 can be unlocked, the workflow 138 can clear the required action and proceed toward import submission. Where the user instead provides a cancellation signal during Phase 1, the cancellation signal can be forwarded by the workflow 138, the user can be notified of the cancellation via the email delivery module 112, the failure and timeout can be recorded, and the workflow 138 can be terminated. Where a timeout condition can be reached without resolution or a cancellation signal, the workflow 138 can similarly be operable to record the failure and timeout and terminate the workflow 138 accordingly. Upon successful clearance of the required action, the workflow 138 can then be advanced to the stage shown in FIG. 5C.

As shown in FIG. 5C, Phase 2 for submitting an import request can be initiated by the workflow 138, which can submit the import and transfer request together with the auth code to the centralized ledger 120. Upon receipt of a response from the centralized ledger 120, where the response can be indicative of an incorrect auth code, the workflow 138 can be operable to set a required action and notify the user via the email delivery module 112 that the auth code can be incorrect and can be in need of updating. The user can be operable to provide an updated auth code or signal to proceed, whereupon the workflow 138 can forward the signal and fetch the updated auth code.

As shown in FIG. 5D, upon receipt of an updated auth code, the workflow 138 can resubmit the import request with the new auth code to the centralized ledger 120. Where the auth code can again be found to be invalid, the workflow 138 can be operable to loop back and re-initiate the auth code notification and update cycle. Should the user signal cancellation during Phase 2, the cancellation signal can be forwarded by the workflow 138, the import request can be cancelled on the centralized ledger 120, the user can be notified of the cancellation via the email delivery module 112, the failure can be recorded as a failed operation 154, and the workflow 138 can be terminated. Where a 7-day timeout can be reached without resolution, the workflow 138 can cancel the pending import request on the centralized ledger 120, notify the user of the timeout via the email delivery module 112, record the failed operation 154, and terminate.

As shown in FIG. 5E, upon successful submission of the import request, the workflow 138 can be advanced to Phase 3 to poll for completion where the orchestration layer 108 can loop and check the import operation status on the centralized ledger 120 until a definitive status of pending, successful, or failure can be returned. Upon a successful import status, the workflow 138 can be advanced to Phase 4 post import where the workflow 138 can extend the registration of the domain name 160 on the centralized ledger 120 where additional registration duration can be needed, and the domain details, including registration information 132, can be retrieved from the centralized ledger 120. The communication module 114 can then be operable to trigger execution of the smart contract 136 on the distributed ledger 122 to accomplish the minting 134 of an NFT 164, where the NFT 164 can be inclusive of the registration information 132 received from the centralized ledger 120. The NFT expiration date 168 within the metadata 166 of the NFT 164 on the distributed ledger 122 can be updated and synchronized with the domain expiration date 162 on the centralized ledger 120, and a blockchain confirmation can be received upon completion. Where the import operation can be found to have resulted in a failure, the workflow 138 can return the failure reason and notify the user via the email delivery module 112, with the failed operation 154 recorded accordingly. Upon completion of all post-import operations across the centralized ledger 120 and the distributed ledger 122, the workflow 138 can be operable to return a success status with the domain details, providing a complete cross-ledger domain name import outcome spanning both the centralized ledger 120 and the distributed ledger 122.

Example 3: Direct Domain Import Workflow with No Errors

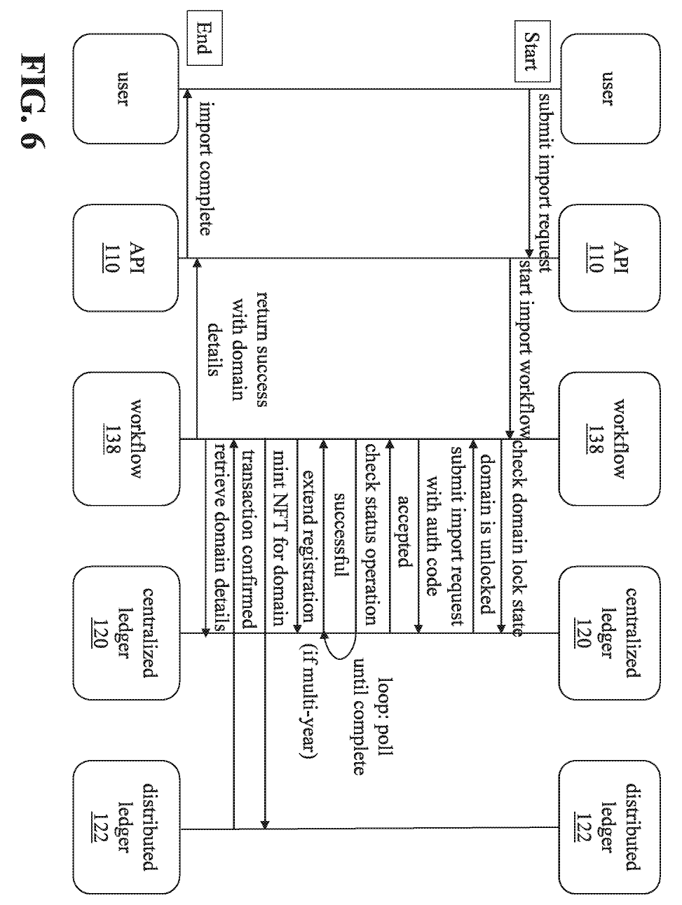

As shown in FIG. 6, an example of a domain name import operation managed by the system 100 across a centralized ledger 120 and a distributed ledger 122 is provided. The workflow 138 can be initiated when a user submits an import request via the API 110, whereupon the orchestration layer 108 can check the lock state of the domain name 160 on the centralized ledger 120. Where the domain name 160 can be found to be in an unlocked state, the workflow 138 can proceed directly to submit the import request together with the auth code to the centralized ledger 120 without requiring user intervention. Upon acceptance, the orchestration layer 108 can be operable to poll the import operation status on the centralized ledger 120 until a successful completion status can be returned, following which the workflow 138 can be advanced to post-import processing. Where the domain name transaction 124 can be for a multi-year registration period, the workflow 138 can extend the registration of the domain name 160 on the centralized ledger 120 accordingly, and the registration information 132 and domain details can then be retrieved from the centralized ledger 120 via the communication module 114.

Upon retrieval of the domain details, the communication module 114 can be operable to trigger execution of the smart contract 136 on the distributed ledger 122 to accomplish the minting 134 of a non-fungible token NFT 164 for the domain name 160, where the NFT 164 can be inclusive of the registration information 132 received from the centralized ledger 120. The NFT expiration date 168 within the metadata 166 of the NFT 164 on the distributed ledger 122 can be set to correspond with the domain expiration date 162 on the centralized ledger 120, ensuring synchronization across both ledgers. Upon receipt of a blockchain transaction confirmation, the workflow 138 can return a success status together with the domain details, providing a complete cross-ledger domain name import outcome spanning both the centralized ledger 120 and the distributed ledger 122.

Example 4: Error Recovery - Domain Import Workflow with Locked Domain Detection

As shown in FIGS. 7A-7C, an example of a domain name import operation managed by the system 100 involving a locked domain name 160 is provided. The workflow 138 in FIGS. 7A-7C can be understood to represent the pre-submit lock state detection phase of the domain name import process, where the domain name 160 can be found to be in a locked state upon initial check, requiring user action before an import request can be submitted to the centralized ledger 120. Resolution paths can be available through hourly polling detection, user-signaled unlocking, user cancellation, or timeout expiration, each coordinated by the orchestration layer 108 via the API 110.

As shown in FIG. 7A, the workflow 138 can be initiated when a resubmit check detects a locked domain name 160 at the start of the import process. The orchestration layer 108 can check the domain lock state on the centralized ledger 120, whereupon the domain name 160 can be found to be in a locked state. Upon detection of the locked state, the workflow 138 can be operable to set a required action and notify the user via the email delivery module 112 that the domain name 160 can be in need of unlocking for transfer. A concurrent wait can then commence by the workflow 138, during which the orchestration layer 108 can simultaneously wait for a signal from the user to proceed or cancel and to poll the domain lock state on the centralized ledger 120 on an hourly loop. A 7-day countdown can be initiated in parallel, and the hourly polling loop can continue checking whether the domain name 160 can be still locked or can now be unlocked, with the workflow 138 advancing to FIG. 7B upon detection of an unlock or upon receipt of a user signal.

As shown in FIG. 7B, two resolution paths can be available to the workflow 138 upon advancement from FIG. 7A. Under the first path, where the hourly polling loop detects that the domain name 160 can now be unlocked, the workflow 138 can notify the user via the email delivery module 112 that the domain name 160 can now be unlocked, clear the required action, and proceed to submit the import request on the centralized ledger 120. Under the second path, where the user signals to proceed after having manually unlocked the domain name 160 at the external registrar, the workflow 138 can be operable to forward the signal, verify with the centralized ledger 120 that the domain name 160 can be unlocked, receive confirmation that the unlock can be confirmed, clear the required action, and proceed to submit the import request. Where the user signals cancellation instead of proceeding, the workflow 138 can be advanced to the stage shown in FIG. 7C.

As shown in FIG. 7C, upon receipt of a cancellation signal from the user, the signal can be forwarded by the workflow 138, the failed operation 154 can be recorded, and the workflow 138 can be terminated without proceeding to submission on the centralized ledger 120. Where the 7-day countdown initiated in FIG. 7A can be reached without resolution whether by user action or by detection of an unlock through the hourly polling loop the workflow 138 can record the failed operation 154 as a timeout, notify the user of the timeout via the email delivery module 112, and terminate the workflow 138 accordingly. Upon either a cancellation or timeout termination, no further operations on the centralized ledger 120 or the distributed ledger 122 can be undertaken, and the domain name transaction 124 can be brought to a failed end state.

Example 5: Error Recovery - Domain Import Workflow with Invalid Auth Code Detection

As shown in FIGS. 8A-8B, an example of a domain name import operation managed by the system 100 where the centralized ledger 120 rejects the initial import request due to an invalid auth code is provided. The workflow 138 in FIGS. 8A-8B can be understood to represent the auth code validation and resolution phase of the domain name import process, where the domain name 160 can be submitted to the centralized ledger 120 with an auth code that can be found to be invalid upon registrar review, requiring user action to provide an updated auth code before the import operation can be resubmitted. Resolution paths can be available through user-directed auth code update and resubmission, user cancellation, or 7-day timeout expiration, each coordinated by the orchestration layer 108 via the API 110.

As shown in FIG. 8A, the workflow 138 can be initiated when an import request together with an auth code can be submitted to the centralized ledger 120 and the registrar response can be found to indicate rejection of the import request due to an invalid auth code. The action type can be determined from the registrar response by the orchestration layer 108, a required action can be set by the workflow 138, and the user can be notified via the email delivery module 112 that the auth code can be invalid and can be in need of updating. The workflow 138 can then wait for a user signal to proceed with an updated auth code, with a 7-day countdown active during the wait period. Where the user can be operable to update the auth code and signal to proceed, the signal can be forwarded by the workflow 138.

As shown in FIG. 8B, upon receipt of the forwarded signal, the workflow 138 can fetch the order details and update the order with the new auth code provided by the user. The import request can then be resubmitted to the centralized ledger 120 with the new auth code, and upon receipt of a response from the centralized ledger 120, where the new auth code can be accepted, the workflow 138 can be operable to proceed to poll for the import completion status on the centralized ledger 120. Where the new auth code can again be found to be invalid upon resubmission, the workflow 138 can loop back to re-initiate the notification and wait cycle, setting the required action and notifying the user of the continued auth code invalidity via the email delivery module 112. Where the user can be operable to signal cancellation during the wait period, the cancellation signal can be forwarded by the workflow 138, the pending import request can be cancelled on the centralized ledger 120, the failed operation 154 can be recorded, and the workflow 138 can be terminated without proceeding to further operations on the centralized ledger 120 or the distributed ledger 122. Where the 7-day countdown can be reached without resolution, the pending import request can be cancelled on the centralized ledger 120 by the workflow 138, the user can be notified of the timeout via the email delivery module 112, the failed operation 154 can be recorded, and the workflow 138 can be terminated, bringing the domain name transaction 124 to a failed end state.

Example 6: Signal-Based Asynchronous User Communication and Concurrent Workflow State Resolution for Domain Import Error Recovery

As shown in FIG. 9, an example of the signal mechanism and workflow communication architecture of the system 100 for managing a domain name transaction 124 is provided. The signal mechanism can be operable to provide asynchronous bidirectional communication between the user and the workflow 138 through a signal-and-query pattern coordinated by the orchestration layer 108 via the API 110. The signal mechanism can be initiated when the workflow 138 can be encountered with a condition requiring user action during a domain name import operation, such as a locked domain name 160 or an invalid authorization code, at which point the workflow 138 can pause execution and enter a waiting state rather than proceeding or terminating the domain name transaction 124.

Upon encountering a condition requiring user action, a required action can be set by the workflow 138 on the order item, and the user can be notified by the API 110 of the required action type, the domain name 160, and instructions for corrective action at the external registrar. The user can then be operable to take corrective action at the external registrar such as unlocking the domain name 160 for transfer or regenerating an authorization code before interacting further with the workflow 138. Prior to sending a signal, the user can be operable to query the workflow state via the API 110, which can return the current import workflow state including the current state 144, the current required action, and a timeout deadline, allowing the user to confirm the status of the workflow 138 before proceeding. Upon completing the corrective action, the user can transmit a signal to the API 110 in the form of a next action symbol carrying the user identifier and a chosen action of either PROCEED or CANCEL, and the signal can be forwarded by the API 110 to the workflow 138. Upon receipt of a PROCEED signal, the workflow 138 can resume execution and continue with the domain name transaction 124 from the point at which it can have been paused.

The signal mechanism can support two signal types: a Signal to Proceed, indicating that the user can have completed the required corrective action, and a Signal to Cancel, indicating that the user can wish to abort the domain name import operation. The workflow 138 can resolve the waiting state through concurrent monitoring of three channels simultaneously the user signal, periodic automatic re-verification via the centralized ledger 120 such as hourly domain lock state polling, and a configurable timeout with a default duration of seven days where whichever channel can produce a resolution event first can be operable to advance the workflow 138 without requiring the other channels to complete. A signal guard can also be implemented by the workflow 138, where incoming signals can only be processed when the workflow 138 can be actively in a waiting state, with signals received at other times silently discarded to prevent race conditions. State persistence 146 can be maintained by the orchestration layer 108 throughout the waiting state, ensuring that the current state 144 of the workflow 138 can be preserved across any operating system failure 148 or operating system restart 150 that can occur during the waiting period, and that the workflow 138 can be resumable without loss of operational context relevant to the domain name transaction 124.

Example 7: Interactive Domain Import Decision Flowchart

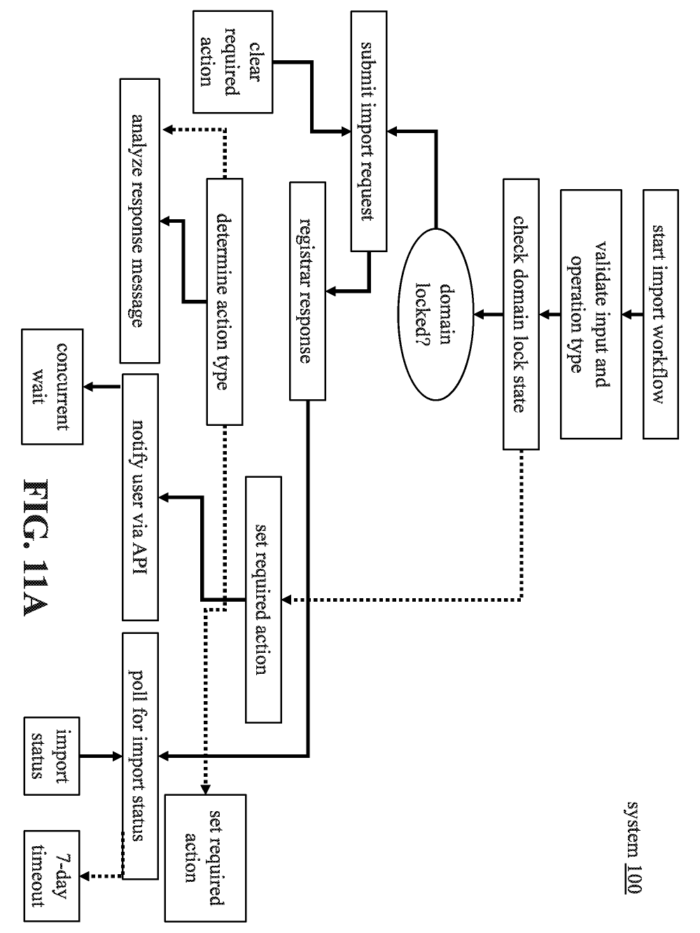

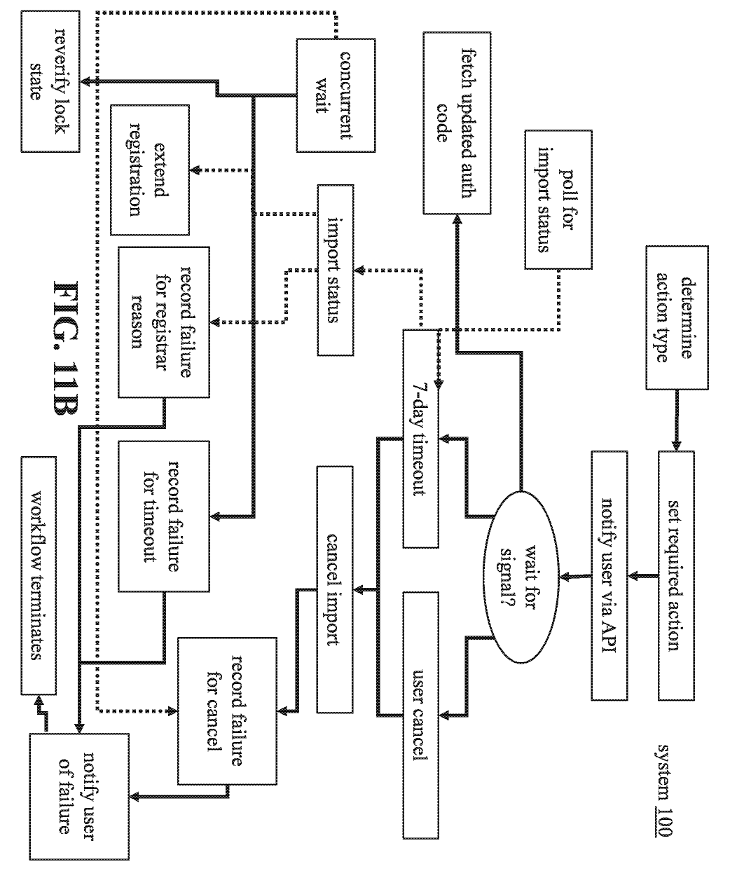

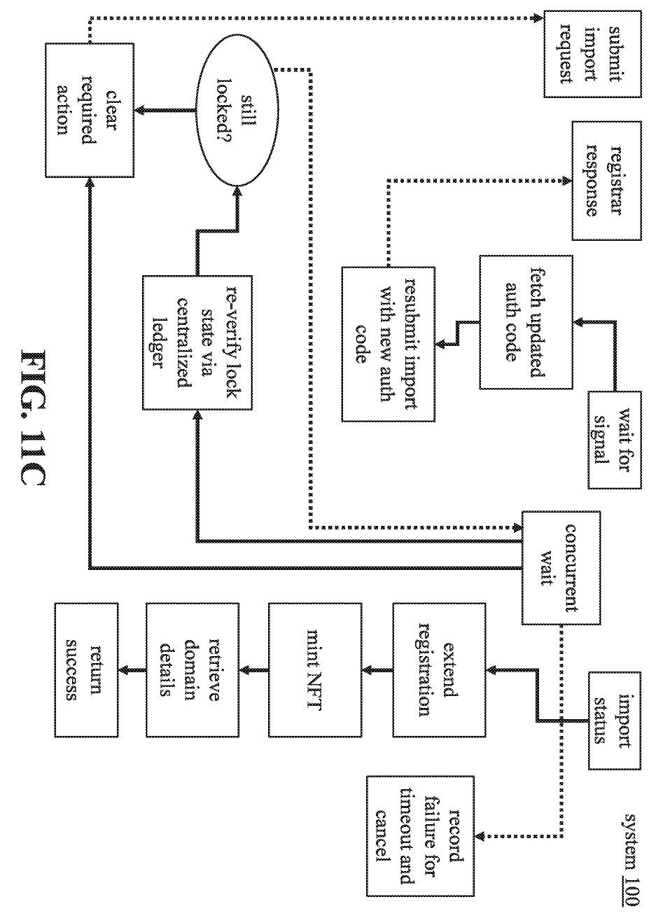

As shown in FIGS. 11A-11C, the interactive import decision flowchart can be understood to illustrate the complete decision logic of the domain name import workflow 138 managed by the orchestration layer 108 across the centralized ledger 120 and the distributed ledger 122. The workflow 138 can process all branching paths from initial lock state verification through error recovery to final completion, with each decision branch coordinated by the orchestration layer 108 via the API 110 and all resolution paths ultimately converging on either a successful minting 134 of a non-fungible token NFT 164 on the distributed ledger 122 or a recorded failed operation 154. As shown in FIGS. 11A-11C, the workflow 138 can be initiated upon receipt of a domain name import request via the API 110, at which point the input can be validated and the operation type can be confirmed imported by the orchestration layer 108. The orchestration layer 108 can then check the domain lock state of the domain name 160 on the centralized ledger 120 via the communication module 114, and the resulting lock state response can determine the initial branching path of the workflow 138.

Where the domain name 160 can be found to be unlocked, the workflow 138 can proceed directly to submit the import request together with the authorization code to the centralized ledger 120 without requiring user intervention. Where the domain name 160 can be found to be locked, a required action of unlocking can be set by the workflow 138, the user can be notified via the email delivery module 112 of the need to unlock the domain name 160 at the external registrar, and a concurrent wait can be commenced by the orchestration layer 108 simultaneously monitoring three resolution channels: a user signal via the API 110, an hourly automatic re-check of the lock state on the centralized ledger 120, and a configurable 7-day timeout. Where the hourly poll can detect that the domain name 160 can now be unlocked, the required action can be cleared and the workflow 138 can proceed to submission. Where the user can proceed after completing the unlock at the external registrar, the lock state can be re-verified on the centralized ledger 120, and upon confirmation of the unlocked state, the required action can be cleared and the workflow 138 can proceed to submission. Where the user can cancel, or where the 7-day timeout can be reached without resolution, the failed operation 154 can be recorded together with the resolution type, the user can be notified via the email delivery module 112, and the workflow 138 can be terminated.

Upon submission of the import request with the authorization code to the centralized ledger 120, the registrar response can determine the next branching path. Where the response can indicate acceptance, the workflow 138 can be advanced to the status polling phase, where the orchestration layer 108 can loop and check the import operation status on the centralized ledger 120 until a definitive status of “pending”, “success”, or “failed” can be returned. Where the response can indicate a condition that requires further action, the action type can be determined by the orchestration layer 108 from the response content: a lock-related condition can route the workflow 138 back to handling unlock requirements, while an authorization code error can route the workflow 138 to handling auth code update requirements, where the user can be notified via the email delivery module 112, and the workflow 138 can enter a 7-day wait for a user signal. Where the user can proceed with an updated authorization code, the updated code can be fetched from the order metadata by the orchestration layer 108 and the import request can be resubmitted to the centralized ledger 120; where the resubmission can require further action, the auth code update cycle can be repeated. Where the response type can be undetermined, the orchestration layer 108 can alert administrators for manual review. Where the user can signal cancel or the 7-day timeout can be reached during auth code handling, the pending import request can be cancelled on the centralized ledger 120, the failed operation 154 can be recorded, and the workflow 138 can be terminated.

Upon receipt of a successful status from the centralized ledger 120, the workflow 138 can be advanced to post-import processing, where the registration of the domain name 160 on the centralized ledger 120 can be extended by the orchestration layer 108 where a multi-year registration period can be applicable. The communication module 114 can then be operable to trigger execution of the smart contract 136 on the distributed ledger 122 to accomplish the minting 134 of an NFT 164 for the domain name 160. Upon receipt of a blockchain transaction confirmation, the domain details can be retrieved by the orchestration layer 108 from the centralized ledger 120 via the communication module 114, and a success status together with the domain details can be returned, bringing the workflow 138 to a completed end state spanning both the centralized ledger 120 and the distributed ledger 122. Where the import status failed, the failure reason can be recorded as a failed operation 154 by the orchestration layer 108, the user can be notified of the failure via the email delivery module 112, and the workflow 138 can be terminated without further operations on the distributed ledger 122.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments can be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A method for managing a domain name transaction for a user across a centralized ledger and a distributed ledger, comprising:
providing a processor and a memory in communication with the processor, the memory including an orchestration layer including an application programming interface (API) and a communication module,
wherein:
the API is configured to receive the domain name transaction from the user, and
the orchestration layer is configured to receive, via the API, the domain name transaction, send, via the communication module, the domain name transaction to the centralized ledger, receive, via the communication module, registration information from the centralized ledger, mint, via the communication module, a non-fungible token (NFT) on the distributed ledger, the NFT including the registration information, and synchronize the registration information with metadata of the NFT across the centralized ledger and the distributed ledger;
receiving, via the API, the domain name transaction from the user;
sending, via the communication module, the domain name transaction to the centralized ledger;
receiving, via the communication module, the registration information from the centralized ledger;
minting, via the communication module, the NFT on the distributed ledger; and
synchronizing the registration information with the metadata of the NFT across the centralized ledger and the distributed ledger.

2. The method of claim 1, wherein:
the metadata of the NFT includes an expiration date of a domain name;
the orchestration layer synchronizes the expiration date across the centralized ledger and the distributed ledger upon successful completion of a domain name renewal; and
the method further comprises:
synchronizing, via the orchestration layer, the expiration date across the centralized ledger and the distributed ledger upon the successful completion of the domain name renewal.

3. The method of claim 1, wherein:
the orchestration layer is further configured to initialize an idempotent workflow execution with an identifier, the identifier including an input parameter of the domain name transaction, and verify a current state of the domain name transaction across the centralized ledger and the distributed ledger based on the identifier; and
the method further comprises:
initializing the idempotent workflow execution with the identifier; and
verifying the current state of the domain name transaction across the centralized ledger and the distributed ledger.

4. The method of claim 1, wherein:
the orchestration layer is further configured to maintain a state persistence across a workflow execution upon an occurrence of a member selected from a group consisting of an operating system failure, an operating system restart, and a combination thereof; and
the method further comprises:
maintaining, via the orchestration layer, the state persistence across the workflow execution upon the occurrence of a member selected from the group consisting of the operating system failure, the operating system restart, and a combination thereof.

5. The method of claim 1, wherein:
the communication module is further configured to execute a member of a group consisting of a domain name transfer, a domain name renewal, and combinations thereof for a domain name associated with the domain name transaction across the centralized ledger and the distributed ledger; and
the method further comprises:
executing a member of the group consisting of the domain name transfer, the domain name renewal, and a combination thereof.

6. The method of claim 1, wherein:
the communication module is further configured to trigger an execution of a smart contract on the distributed ledger to mint the NFT; and
the method further comprises:
triggering, via the communication module, the execution of the smart contract on the distributed ledger to mint the NFT.

7. The method of claim 1, wherein:
the API includes an email delivery module; and
the method further comprises:
transmitting, via the email delivery module, a notification to the user relating to a status of the domain name transaction across the centralized ledger and the distributed ledger.

8. The method of claim 1, wherein:
the memory further includes an interface module; and
the method further comprises:
receiving the domain name transaction at the interface module from the user; and
routing, via the interface module, the domain name transaction to the API of the orchestration layer.

9. The method of claim 1, wherein:
the memory further includes a scheduler; and
the method further comprises:
triggering, via the scheduler, a renewal of a domain name associated with the domain name transaction; and
sending a notification based on the renewal to the communication module.

10. The method of claim 1, wherein:
the memory further includes a scheduler and an interface module;
the orchestration layer is further configured to:
synchronize an expiration date across the centralized ledger and the distributed ledger upon successful completion of a domain name renewal,
initialize an idempotent workflow execution with an identifier, the identifier including an input parameter of the domain name transaction,
verify a current state of the domain name transaction across the centralized ledger and the distributed ledger based on the identifier, and
maintain a state persistence across a workflow execution upon an occurrence of a member selected from a group consisting of an operating system failure, an operating system restart, and a combination thereof;
the communication module is further configured to:
execute a member of a group consisting of a domain name transfer, the domain name renewal, and combinations thereof for a domain name associated with the domain name transaction across the centralized ledger and the distributed ledger, and
trigger an execution of a smart contract on the distributed ledger to mint the NFT;
the metadata of the NFT includes the expiration date of the domain name;
the API includes an email delivery module; and
the method further comprises:
synchronizing, via the orchestration layer, the expiration date across the centralized ledger and the distributed ledger upon the successful completion of the domain name renewal;
initializing the idempotent workflow execution with the identifier;
verifying the current state of the domain name transaction across the centralized ledger and the distributed ledger;
maintaining, via the orchestration layer, the state persistence across the workflow execution upon the occurrence of a member selected from the group consisting of the operating system failure, the operating system restart, and a combination thereof;
executing a member of the group consisting of the domain name transfer, the domain name renewal, and a combination thereof;
triggering, via the communication module, the execution of the smart contract on the distributed ledger to mint the NFT;
transmitting, via the email delivery module, a notification to the user relating to a status of the domain name transaction across the centralized ledger and the distributed ledger;
receiving the domain name transaction at the interface module from the user;
routing, via the interface module, the domain name transaction to the API of the orchestration layer;
triggering, via the scheduler, a renewal of the domain name associated with the domain name transaction; and
sending the notification based on the renewal to the communication module.

11. A system for managing a domain name transaction for a user across a centralized ledger and a distributed ledger, comprising:
a processor; and
a memory in communication with the processor, the memory including an orchestration layer including an application programming interface (API) and a communication module,
wherein:
the API is configured to receive the domain name transaction from the user; and
the orchestration layer is configured to:
receive, via the API, the domain name transaction,
send, via the communication module, the domain name transaction to the centralized ledger,
receive, via the communication module, registration information from the centralized ledger,
mint, via the communication module, a non-fungible token (NFT) on the distributed ledger, the NFT including the registration information, and
synchronize the registration information with metadata of the NFT across the centralized ledger and the distributed ledger.

12. The system of claim 11, wherein the orchestration layer is further configured to:
initialize an idempotent workflow execution with an identifier, the identifier including an input parameter of the domain name transaction, and
verify a current state of the domain name transaction across the centralized ledger and the distributed ledger based on the identifier.

13. The system of claim 11, wherein the orchestration layer is further configured to maintain a state persistence across a workflow execution upon an occurrence of a member selected from a group consisting of an operating system failure, an operating system restart, and a combination thereof.

14. The system of claim 11, wherein the orchestration layer is further configured to implement an automatic retry mechanism for a failed operation across the centralized ledger and the distributed ledger.

15. The system of claim 11, wherein the API includes an email delivery module configured to transmit a notification to the user based on a status of the domain name transaction across the centralized ledger and the distributed ledger.

16. The system of claim 11, wherein the communication module is further configured to execute a member of a group consisting of a domain name transfer, a domain name renewal, and combinations thereof for a domain name associated with the domain name transaction across the centralized ledger and the distributed ledger.

17. The system of claim 11, wherein the communication module is further configured to trigger an execution of a smart contract on the distributed ledger to mint the NFT.

18. The system of claim 11, wherein the metadata of the NFT includes an expiration date of a domain name, and the orchestration layer synchronizes the expiration date across the centralized ledger and the distributed ledger upon successful completion of a domain name renewal.

19. The system of claim 11, wherein the memory further includes a scheduler configured to trigger a renewal of a domain name associated with the domain name transaction and send a notification based on the renewal to the communication module.

20. A non-transitory computer-readable medium storing instructions for managing a domain name transaction for a user across a centralized ledger and a distributed ledger that, when executed by a processor, causes the processor to:
receive, via an application programming interface (API) of an orchestration layer, the domain name transaction from the user;
send, via a communication module of the orchestration layer, the domain name transaction to the centralized ledger;
receive, via the communication module, registration information from the centralized ledger;
mint, via the communication module, a non-fungible token (NFT) on the distributed ledger, the NFT including the registration information; and
synchronize the registration information with metadata of the NFT across the centralized ledger and the distributed ledger.
